(19) United States
(12) Patent Application Publication
(10) Pub. No.: US 2007/0233563 A1
(43) Pub. Date: Oct. 4, 2007

(54) Web-page sorting apparatus, web-page sorting method, and computer product

(75) Inventors: Tetsuro Takahashi, Kawasaki (JP); Kanji Uchino, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/485,439

(22) Filed: Jul. 13, 2006

(30) Foreign Application Priority Data
Mar. 30, 2006 (JP) 2006-094350

(51) Int. Cl. G06Q 30/00

(52) U.S. Cl. 705/14

(57) ABSTRACT

An advertisement page on which an article written by an advertiser are sorted from web pages that are used for posting articles on the Internet. A word list is prepared in which words including unique expressions are registered. Words are extracted from text information included in the web pages, a number is counted indicating how many words match between the words contained in the word list and the extracted words, and the advertisement page is sorted out from the web pages based on the count.

### BACKGROUND OF THE INVENTION

1. Field of the Invention

The present invention relates to a technology for sorting web pages.

2. Description of the Related Art

Conventionally, for the purpose of doing marketing with analysis of consumers' opinions and consumption activities, information related to reputations of commercial products and corporations (hereinafter, “reputation information”) is extracted and analyzed out of the information (Consumer Generated Media (CGM)) posted on the Internet by consumers. For example, the Japanese Patent Application Laid-open No. 2002-175330 discloses a method for searching and extracting reputation information related to a search word (for example, the name of a commercial product) that is determined by the person who extracts the reputation information, out of a web page on which information is posted on the Internet.

Some of the web pages on which information is posted on the Internet include a large number of spam blogs and blog-type commerce pages (hereinafter, “advertisement pages”) that are deliberately generated by advertisers. It is often the case with these advertisement pages that only the strong points of the commercial products are written, for example, and that the posted information is too biased to be treated as reputation information.

For this reason, Japanese Patent Application Laid-open No. 2004-70405 discloses a method in which the person who extracts the reputation information specifies, in advance, Uniform Resource Locators (URLs) of the web pages that are used as the targets of the reputation information extraction or the web pages that are excluded from the targets of the reputation information extraction. With this arrangement, the advertisement pages are sorted out from other web pages, and the web pages that are used as the targets of the reputation information extraction are limited to the web pages that are different from the advertisement pages having been sorted out.

According to the conventional technique, the advertisement pages are sorted out based on the URLs specified by the person who extracts the reputation information. Thus, it is not easy to sort out the advertisement pages. This method has its limits because the Internet requires that a huge amount of information be covered thoroughly and also that the information, which is updated daily, be followed up immediately. Thus, a problem arises where, when the advertisement pages are not appropriately sorted out, the degree of precision is lowered in the results of the analysis obtained by extracting and analyzing the reputation information from the web pages.

### SUMMARY OF THE INVENTION

It is an object of the present invention to at least partially solve the problems in the conventional technology.

According to an aspect of the present invention, a web-page sorting apparatus that sorts out an advertisement page on which an article written by an advertiser is posted, from web pages that are used for posting articles on the Internet includes a word-list holding unit that stores therein a word list in which words including unique expressions are registered; a word extracting unit that extracts words from text information included in the web pages; a quantity counting unit that counts a number indicating how many words match between the words contained in the word list and the words extracted by the word extracting unit; and a web-page sorting unit that sorts out the advertisement page from the web pages based on the number counted by the quantity counting unit.

According to another aspect of the present invention, a web-page sorting apparatus that sorts out an advertisement page on which an article written by an advertiser is posted, from web pages that are used for posting articles in a chronological order on the Internet and that structures at least one web site includes an article posting-number counting unit that counts a number indicating how many times articles are posted on at least one web page that structures a single web site; and a web-page sorting unit that sorts out the advertisement page from the web pages, based on the number indicating how many times the articles are posted that is counted by the article posting-number counting unit.

According to still another aspect of the present invention, a web-page sorting apparatus that sorts out an advertisement page on which an article written by an advertiser is posted, from web pages that are used for posting articles in a chronological order on the Internet and that structures at least one web site includes a similarity-level calculating unit that calculates a level of similarity among a plurality of articles posted on at least one web page that structures a single web site; and a web-page sorting unit that sorts out the advertisement page from the web pages based on the level of similarity calculated by the similarity-level calculating unit.

According to still another aspect of the present invention, a method of sorting out an advertisement page on which an article written by an advertiser is posted, from web pages that are used for posting articles on the Internet includes holding a word list in which words including unique expressions are registered; extracting words from text information included in the web pages; counting a number indicating how many words match between the words contained in the word list held at the holding and the words extracted at the extracting; and sorting out the advertisement page from the web pages based on the number counted at the counting.

According to still another aspect of the present invention, a method of sorting out an advertisement page on which an article written by an advertiser is posted, from web pages that are used for posting articles in a chronological order on the Internet and that structures at least one web site includes counting a number indicating how many times articles are posted on at least one web page that structures a single web site; and sorting out the advertisement page from the web pages based on the number counted at the counting.

According to still another aspect of the present invention, a method of sorting out an advertisement page on which an article written by an advertiser is posted, from web pages that are used for posting articles in a chronological order on the Internet and that structures at least one web site includes calculating a level of similarity among articles posted on at least one web page that structures a single web site; and sorting the advertisement page from the web pages, based on the level of similarity calculated at the calculating.

According to still another aspect of the present invention, a computer-readable recording medium stores therein a computer program that causes a computer to implement the above method(s).

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic for explaining the concept and the characteristics of a web-page sorting apparatus according to a first embodiment of the present invention;

FIG. 2 is a detailed functional block diagram of the web-page sorting apparatus according to the first embodiment;

FIG. 3 is a table for explaining the contents of an extracted-word storing unit shown in FIG. 2;

FIG. 4 is a table for explaining the contents of a word-list holding unit shown in FIG. 2;

FIG. 5 is a table for explaining the contents of a quantity storing unit shown in FIG. 2;

FIG. 6 is a table for explaining the contents of a web-page sorting result storing unit shown in FIG. 2;

FIG. 7 is a flowchart of the processing performed by the web-page sorting apparatus shown in FIG. 2;

FIG. 8 is a flowchart of a word extracting processing shown in FIG. 7;

FIG. 9 is a flowchart of a web-page sorting processing shown in FIG. 7;

FIG. 10 is a schematic for explaining the concept and the characteristics of a web-page sorting apparatus according to a second embodiment of the present invention;

FIG. 11 is a detailed functional block diagram of the web-page sorting apparatus according to the second embodiment;

FIG. 12 is a table for explaining the contents of an article posting-number storing unit shown in FIG. 11;

FIG. 13 is a table for explaining the contents of a web-page sorting result storing unit shown in FIG. 11;

FIG. 14 is a flowchart of the processing performed by the web-page sorting apparatus shown in FIG. 11;

FIG. 15 is a flowchart of an article posting-number counting processing shown in FIG. 14;

FIG. 16 is a flowchart of a web-page sorting processing shown in FIG. 14;

FIG. 17 is a schematic for explaining the concept and the characteristics of a web-page sorting apparatus according to a third embodiment of the present invention;

FIG. 18 is a detailed functional block diagram of the web-page sorting apparatus according to the third embodiment;

FIG. 19 is a table for explaining the contents of a similarity-level storing unit shown in FIG. 18;

FIG. 20 is a table for explaining the contents of a web-page sorting result storing unit shown in FIG. 18;

FIG. 21 is a flowchart of the processing performed by the web-page sorting apparatus shown in FIG. 18;

FIG. 22 is a flowchart of a similarity-level calculating processing shown in FIG. 21;

FIG. 23 is a flowchart of a web-page sorting processing shown in FIG. 21;

FIG. 24 is a block diagram of a computer that implements the processes, methods, steps according to the first embodiment;

FIG. 25 is a block diagram of a computer that implements the processes, methods, steps according to the second embodiment; and

FIG. 26 is a block diagram of a computer that implements the processes, methods, steps according to the third embodiment.

### DETAILED DESCRIPTION OF THE PREFERRED EMBODIMENTS

Exemplary embodiments of the present invention will be explained in detail with reference to the accompanied drawings. The present invention is not limited to the embodiments explained below.

Firstly, principal terms used in the exemplary embodiments will be explained. In the description of the embodiments, a web page is a document used for posting articles on the Internet, using the World Wide Web (WWW) system. To be more specific, a web page is configured so as to include text information, layout information written in a Hyper Text Markup Language (HTML), and images and sounds that are embedded in the document. The entire data that is displayed on a web browser at one time corresponds to one web page. Normally, a group of such web pages is collectively published on the Internet and is called a web site. In other words, a web site is a group of web pages that includes a web page having a function of a cover or a table of contents (i.e. a top page) and other web pages that are linked to the top page.

The web sites on the Internet include some web sites that have been conventionally used in which the layout information is written in an HTML by the creators of the web sites and also other web sites that do not require the creators of the web sites to be conscious of HTML codes. A typical example of the web sites of the latter kind is a blog. A blog has a function of posting articles in a chronological order with a Contents Management System (CMS), a function of making a link with an article posted on another web site (i.e. track back), and a comment function.

This type of web sites (called blogs) has become popular among general users of the Internet because it is easy to structure the web sites. Thus, a large number of articles that contain consumers' opinions have been posted. On the other hand, some web sites (blogs) are advertisement pages called spam blogs and blog-type commerce pages in which the articles that are deliberately written by the advertisers are posted. In this situation, to extract and analyze information related to reputations of commercial products and corporations, out of the web pages used for posting information on the Internet, it is necessary to sort out the advertisement pages from the web pages, so as to exclude the advertisement pages from the targets of the analysis.

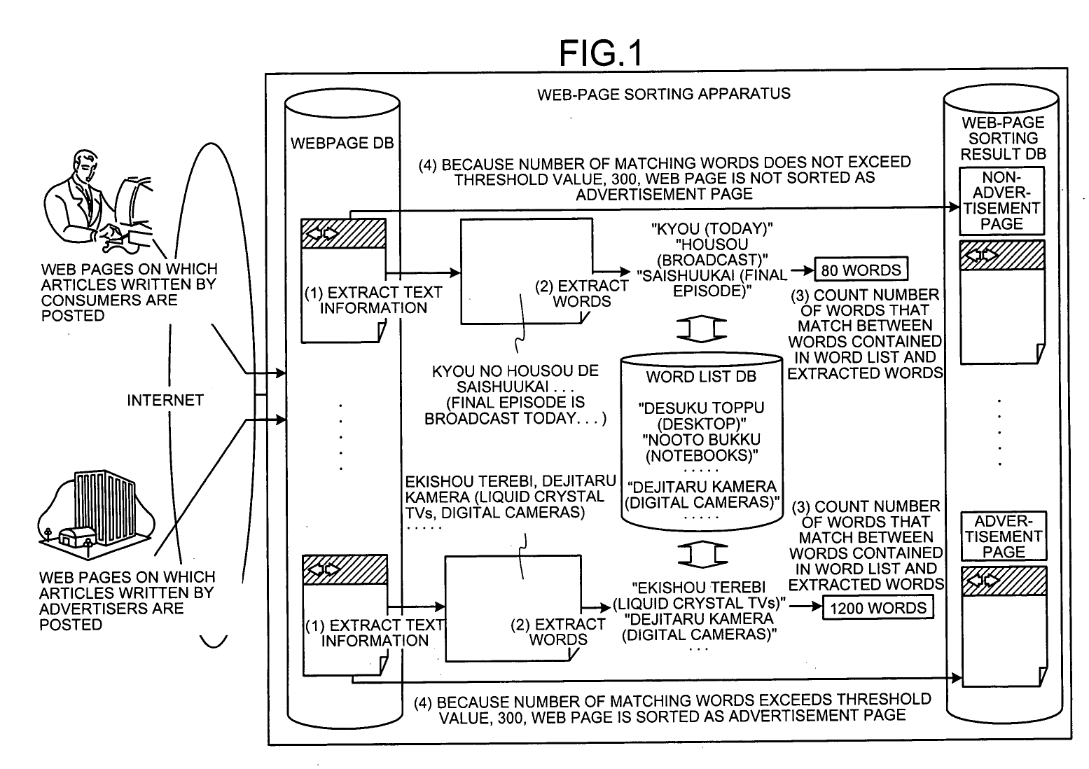

FIG. 1 is a schematic for explaining the concept and the characteristics of a web-page sorting apparatus according to a first embodiment of the present invention. In the following description, both (i) a group of web pages structuring a web site and (ii) a single web page that is published without structuring a web site are used as the targets of the sorting process. Also, both (iii) web pages structuring websites that have conventionally been used in which the layout information is written in an HTML by the creators of the web sites and (iv) web pages structuring web sites that do not require the creators of the web sites to be conscious of HTMLs are used as the targets of the sorting process.

As explained above, the overview of the web-page sorting apparatus according to the first embodiment can be summarized as the function of sorting out the advertisement pages on which articles written by the advertisers are posted, from the web pages used for posting articles on the Internet. The principal characteristics of the web-page sorting apparatus according to the first embodiment can be summarized as follows: Compared to other methods of sorting out advertisement pages in which the person who extracts reputation information needs to specify the URLs, this method makes it possible to sort out advertisement pages more easily. It is possible to sort out advertisement pages appropriately without lowering the degree of precision in the results of the analysis obtained by extracting and analyzing the reputation information from the web pages, even though the Internet requires that a huge amount of information be covered thoroughly and also that the information, which is updated daily, be followed up immediately.

To explain the principal characteristics briefly, as shown in FIG. 1, the web-page sorting apparatus according to the first embodiment stores therein, in advance, a word list in which words including unique expressions (e.g. expressions related to particular commercial products such as “desktop” and “notebooks”, specific names of commercial products, names of corporations, and names of organizations) in a large number of categories are registered. Also, the web-page sorting apparatus stores therein the web pages that are used as the targets of the sorting process.

Firstly, the web-page sorting apparatus according to the first embodiment extracts words from the text information included in the web pages (See, (1) and (2) in FIG. 1). For example, the phrase “Kyou no housou de saishuukai (the final episode is broadcast today), . . . ” is extracted as text information from the web page. Then, the words “kyou (today)”, “housou (broadcast)”, “saishuukai (the final episode)”, and the like are extracted from the text information. As another example, the phrase “Ekishou terebi, dejitaru kamera (Liquid crystal TVs, digital cameras), . . . ” is extracted as text information from the web page. Then, the words “ekishou terebi (liquid crystal TVs)”, “dejitaru kamera (digital cameras)”, and the like are extracted from the text information.

Next, the web-page sorting apparatus counts how many of the words that are contained in the word list match the extracted words (See, (3) in FIG. 1). For example, in the word list, words that include unique expressions such as “desuku toppu (desktop)” “nooto bukku (notebooks)” “dejitaru kamera (digital cameras)” are registered in a large number of categories. It is counted how many of the words in the list match the extracted words such as “kyou (today)”, “housou (broadcast)”, “saishuukai (the final episode)”, and the like. For example, as a result of the counting process, 80 is the quantity of the matching words. As another example, it is counted how many of the words in the list match the extracted words such as “ekishou terebi (liquid crystal TVs)”, “dejitaru kamera (digital cameras)”, and the like. For example, as a result of the counting process, 1200 is the quantity of the matching words.

Then, the web-page sorting apparatus sorts out the advertisement pages from the web pages, based on the number of words obtained in the counting process (See, (4) in FIG. 1). For example, the web-page sorting apparatus according to the first embodiment sets a threshold value to 300. When the number of matching words counted is equal to or larger than the threshold value, it is determined that the web page will be sorted as an advertisement page. When the number of matching words counted is smaller than the threshold value, it is determined that the web page will not be sorted as an advertisement page (i.e. the web page will be sorted as a non-advertisement page). In other words, it is considered that the text information in advertisement pages contain a large number of words including unique expressions. Thus, when the number of words including unique expressions on a web page is equal to or larger than the predetermined threshold value, the web page is sorted as an advertisement page. In the example shown in FIG. 1, the web-page sorting apparatus sorts out the web page in which 80 words are counted as the matching words as a non-advertisement page, because it is smaller than the threshold value, which is 300. Also, the web-page sorting apparatus sorts out the web page in which 1200 words are counted as the matching words as an advertisement page, because it is larger than the threshold value, which is 300.

With the above arrangement, when the web-page sorting apparatus according to the first embodiment is used, it is possible to sort out the advertisement pages more easily, compared to other methods of sorting out advertisement pages in which the person who extracts reputation information needs to specify the URLs. Thus, it is possible to sort out the advertisement pages appropriately without lowering the degree of precision in the results of the analysis obtained by extracting and analyzing the reputation information from the web pages, even though the Internet requires that a huge amount of information be covered thoroughly and also that the information, which is updated daily, be followed up immediately.

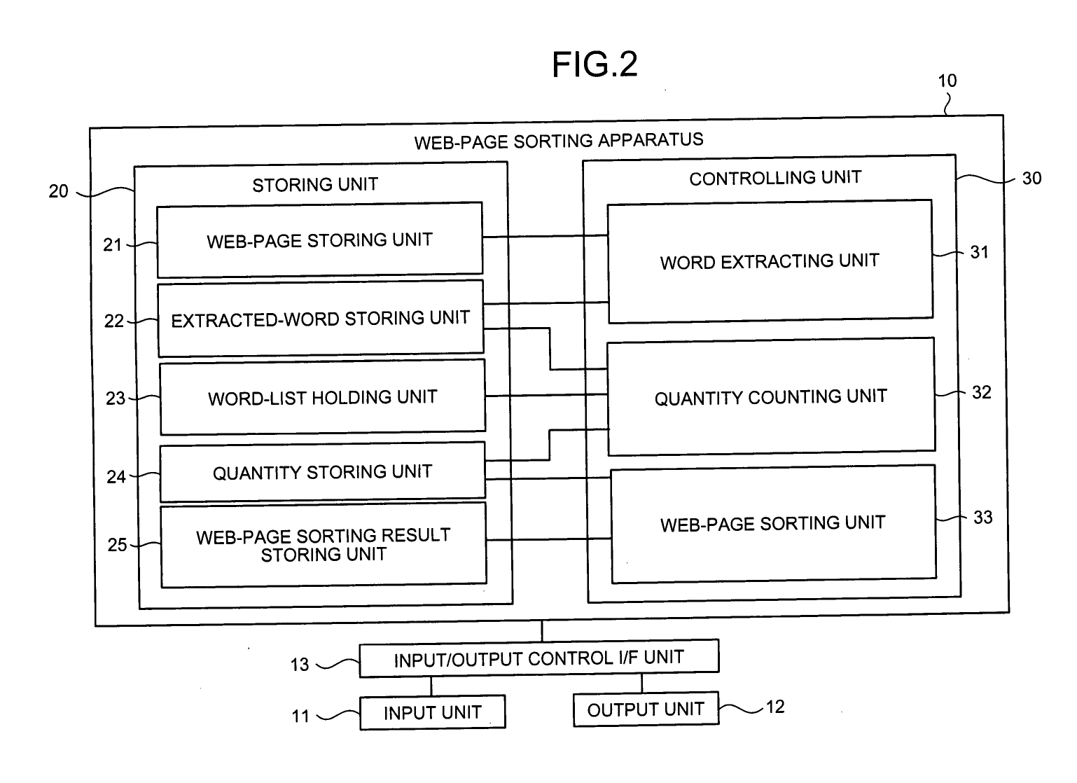

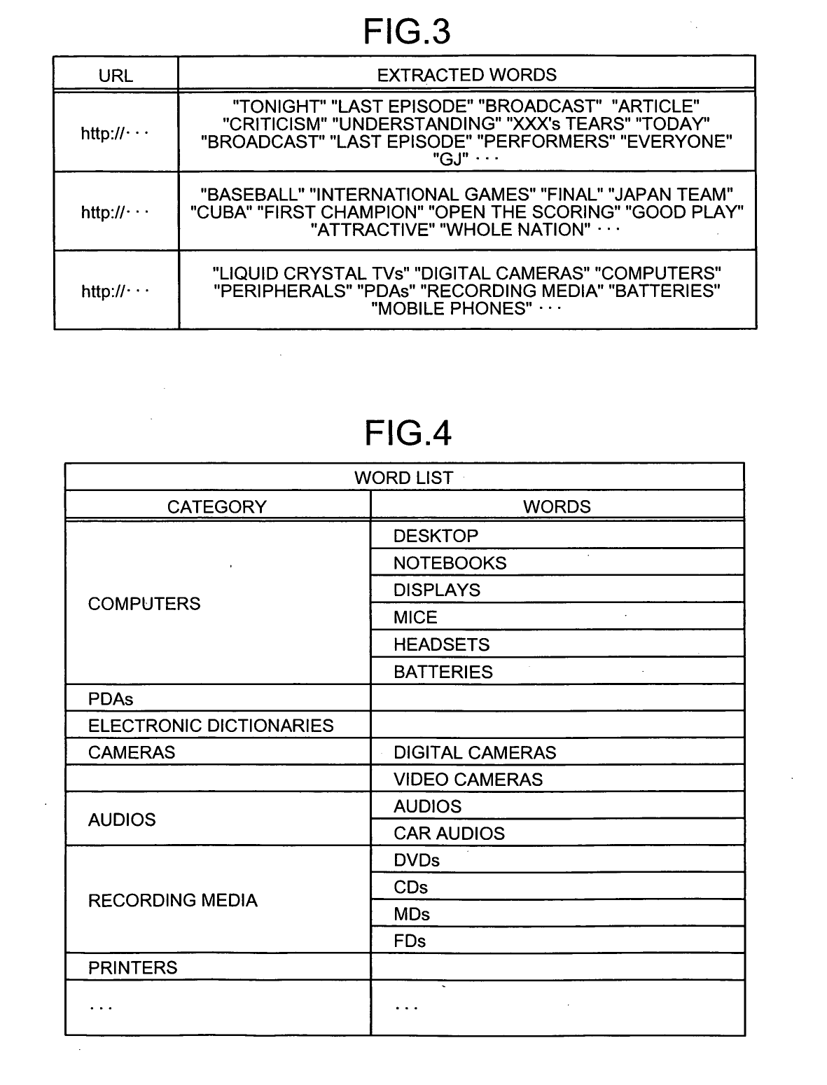

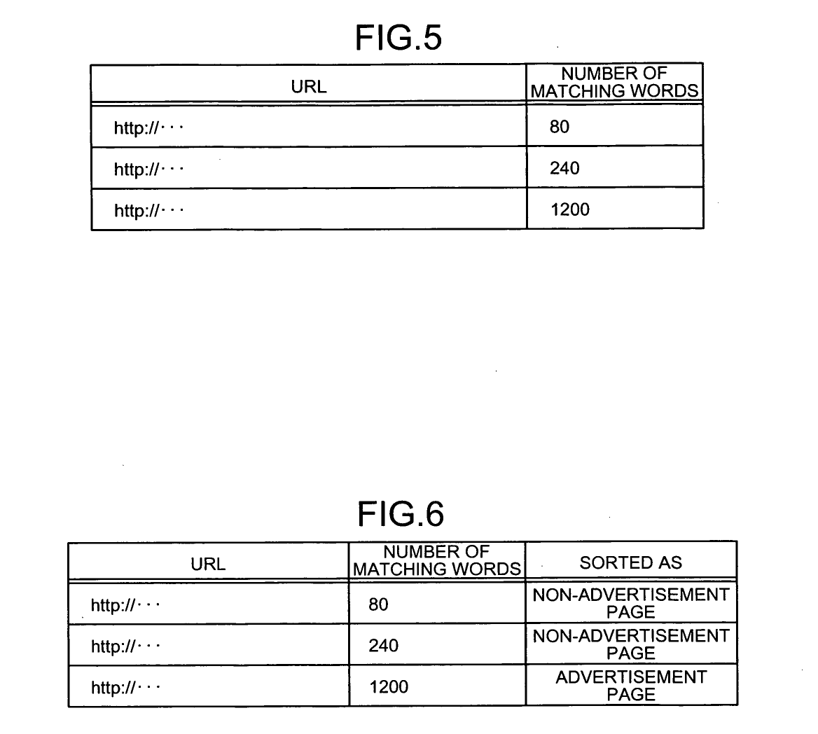

Next, the configuration of the web-page sorting apparatus according to the first embodiment will be explained with reference to FIGS. 2 to 6. FIG. 2 is a detailed functional block diagram of a web-page sorting apparatus 10 according to the first embodiment. FIG. 3 is a table for explaining the contents of an extracted-word storing unit 22 shown in FIG. 2. FIG. 4 is a table for explaining the contents of a word-list holding unit 23 shown in FIG. 2. FIG. 5 is a table for explaining the contents of a quantity storing unit 24 shown in FIG. 2. FIG. 6 is a table for explaining the contents of a web-page sorting result storing unit 25 shown in FIG. 2.

As shown in FIG. 2, the web-page sorting apparatus 10 includes an input unit 11, an output unit 12, an input/output control interface (I/F) unit 13, a storing unit 20, and a control unit 30.

The input unit 11 is used for inputting the data that is used in various types of processing performed by the control unit 30 and the operation instructions for performing various types of processing, with a keyboard, a storage medium, or through communications. To be more specific, the input unit 11 inputs a word list in which the words including unique expression in a large number of categories are registered and stores the word list into the word-list holding unit 23. Also, the input unit 11 inputs web pages that are used for posting articles on the Internet and stores the web pages into a web-page storing unit 21.

The output unit 12 outputs the results of various types of processing performed by the control unit 30 and the operation instructions for performing various types of processing to a monitor, a printer, or the like. To be more specific, the output unit 12 outputs the sorting results that are stored in the web-page sorting result storing unit 25.

The input/output control I/F unit 13 controls the data transfer between the input unit 11 and the output unit 12; and between the storing unit 20 and the control unit 30.

The storing unit 20 stores therein the data used in various types of processing performed by the control unit 30. In particular, the storing unit 20 includes, as shown in FIG. 2, the web-page storing unit 21, the extracted-word storing unit 22, the word-list holding unit 23, the quantity storing unit 24, and the web-page sorting result storing unit 25.

The web-page storing unit 21 stores therein the web pages that are used as the targets of the sorting process performed by the web-page sorting apparatus 10. To be more specific, the web-page storing unit 21 stores therein the web pages input by the input unit 11.

The extracted-word storing unit 22 stores therein the words extracted from the text information included in the web pages that are used as the targets of the sorting process performed by the web-page sorting apparatus 10. To be more specific, the extracted-word storing unit 22 stores therein the words extracted by a word extracting unit 31 from the text information included in the web pages stored in the web-page storing unit 21. For example, as shown in FIG. 3, the extracted-word storing unit 22 stores therein URLs, which is the address information of the web pages, and the extracted words while associating the URLs and the extracted words with one another.

The word-list holding unit 23 stores therein the word list held by the web-page sorting apparatus 10. To be more specific, the word-list holding unit 23 stores therein the word list that is input by the input unit 11 and in which the words including unique expressions in a large number of categories are registered. For example, as shown in FIG. 4, the word-list holding unit 23 stores therein a word list in which words that are related to each of the large number of categories are registered. The examples of the categories include “computers”, “personal digital assistants (PDAs)”, “electronic dictionaries”, “cameras”, “audios”, “recording media”, and “printers”. Although the examples of the categories are shown in FIG. 4, the present invention is not limited to this example. Any other categories can be set depending on the purpose of use. For example, “automobiles”, “personal computers (PCs)”, and “cosmetics” can be used as the categories.

The quantity storing unit 24 stores therein the number of words that match between the words contained in the word list held by the web-page sorting apparatus 10 and the words extracted from the text information included in the web pages that are used as the targets of the sorting process performed by the web-page sorting apparatus 10. To be more specific, the quantity storing unit 24 stores therein the number of words that match between the words contained in the word list held by the word-list holding unit 23 and the words extracted by the word extracting unit 31, the number of matching words being counted by a quantity counting unit 32. For example, as shown in FIG. 5, the quantity storing unit 24 stores therein URLs, and the counted number of matching words, while associating the URLs and the counted number with one another.

The web-page sorting result storing unit 25 stores therein the results of the sorting process to sort out advertisement pages from the web pages, performed by the web-page sorting apparatus 10. To be more specific, the web-page sorting result storing unit 25 stores therein the results obtained through the sorting process to sort out the advertisement pages from the web pages, performed by a web-page sorting unit 33. For example, as shown in FIG. 6, the web-page sorting result storing unit 25 stores therein the URLs, the counted number of matching words, and the results of the sorting process (non-advertisement pages or advertisement pages), while associating the URLs, the counted number, and the sorting results with one another. According to the first embodiment, the threshold value for the number of matching words is set to 300, for example. When the counted number of matching words is equal to or larger than 300, it is determined that the web page will be sorted as an advertisement page. When the counted number of matching words is smaller than 300, it is determined that the web page will not be sorted as an advertisement page (i.e. the web page will be sorted as a non-advertisement page).

Returning to the explanation of FIG. 2, the control unit 30 controls the web-page sorting apparatus 10 so that various types of processing are performed. In particular, the control unit 30 includes, the word extracting unit 31, the quantity counting unit 32, and the web-page sorting unit 33.

The word extracting unit 31 extracts the words from the text information included in the web pages. To be more specific, the word extracting unit 31 extracts the words from the text information included in the web pages stored in the web-page storing unit 21 and stores the extracted words into the extracted-word storing unit 22. The specific processing performed by the word extracting unit 31 will be explained in detail in the description of the processing performed by the web-page sorting apparatus according to the first embodiment later.

The quantity counting unit 32 is a unit that counts the number of words that match between the words contained in the word list and the words that are extracted from the text information included in the web pages. To be more specific, the quantity counting unit 32 counts the number of words that match between the words contained in the word list held by the word-list holding unit 23 and the words that are stored by the extracted-word storing unit 22 and stores the counted number of matching words into the quantity storing unit 24.

The web-page sorting unit 33 sorts out the advertisement pages from the web pages based on the counted number of matching words. To be more specific, the web-page sorting unit 33 sorts out the advertisement pages from the web pages, based on the number of matching words stored in the quantity storing unit 24, and stores the result of the sorting process into the web-page sorting result storing unit 25. The specific processing performed by the web-page sorting unit 33 will be explained in detail in the description of the processing performed by the web-page sorting apparatus according to the first embodiment later.

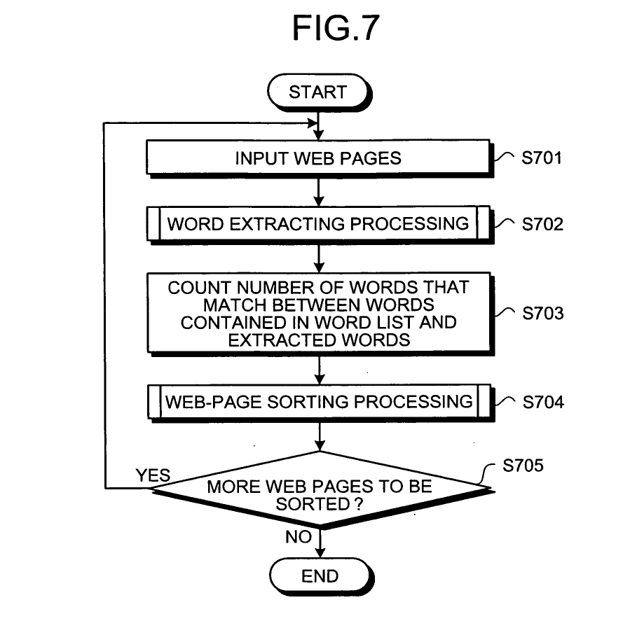

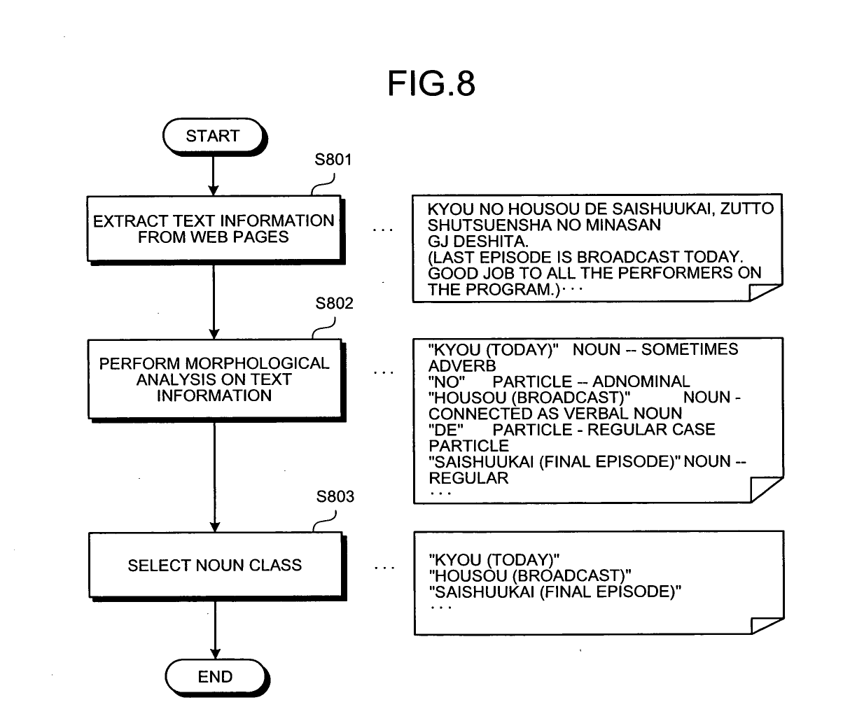

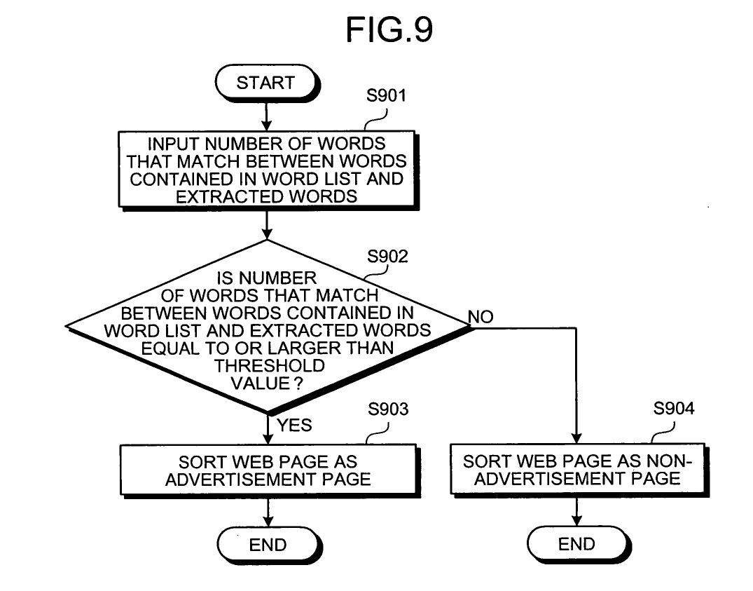

Next, the processing performed by the web-page sorting apparatus 10 will be explained, with reference to FIGS. 7 to 9. FIG. 7 is a flowchart of the processing performed by the web-page sorting apparatus 10. FIG. 8 is a flowchart of a word extracting processing shown in FIG. 7. FIG. 9 is a flowchart of a web-page sorting processing shown in FIG. 7.

As shown in FIG. 7, the word extracting unit 31 receives an input of web pages that are to be used as the targets of the sorting process, from the web-page storing unit 21 (step S701).

Next, the word extracting unit 31 extracts words from the text information included in the web pages that have been received as the input, so that the extracted words are stored into the extracted-word storing unit 22 (step S702).

Then, the quantity counting unit 32 counts the number of words that match between the words contained in the word list held by the word-list holding unit 23 and the words stored by the extracted-word storing unit 22, so that the number of matching words that has been counted is stored into the quantity storing unit 24 (step S703).

Subsequently, the web-page sorting unit 33 sorts out advertisement pages, based on the number of matching words stored by the quantity storing unit 24, so that the result of the sorting process is stored into the web-page sorting result storing unit 25 (step S704).

Next, the web-page sorting apparatus 10 determines whether there exist other web pages that are to be used as the targets of the sorting process (step S705). When there exist other web pages that are to be used as the targets of the sorting process (step S705: Yes), the process control returns to step S701. On the other hand, when there exist no other web pages that are to be used as the targets of the sorting process (step S705: No), the web-page sorting apparatus 10 terminates the processing.

Next, the word extracting processing at step S702 in FIG. 7 will be explained in detail. As shown in FIG. 8, the word extracting unit 31 extracts the text information from the web pages that have been received as the input (step S801). For example, as shown in FIG. 8, the text information reading “Kyou no housou de saishuukai, zutto shutsuensha no minasan GJ deshita (The final episode is broadcast today. Good Job to all the performers on the program)” is extracted.

Then, the word extracting unit 31 performs a morphological analysis on the extracted text information (step S802). In other words, the text information written in a natural language is divided into morphemes (each of which is the smallest unit that can carry meaning in a language), and the parts of speech are identified. For example, when a morphological analysis is performed on the example of the text information used above, the text information is divided into the morphemes such as “kyou (today)”, “no”, “housou (broadcast)”, “de”, “saishuukai (the final episode)”, and the part of speech of each of the morphemes is analyzed.

Subsequently, the word extracting unit 31 selects only the morphemes of which the parts of speech are in the noun class, out of the analyzed morphemes (step S803); and the word extracting processing terminates. In the description of the first embodiment, the example in which the morphological analysis is used as a means of extracting words is explained. However, the present invention is not limited to this example. It is acceptable to use any other methods, as long as it is possible to extract words from the text information.

Next, the web-page sorting processing at step S704 in FIG. 7 will be explained in detail. As shown in FIG. 9, the web-page sorting unit 33 receives an input of the number of matching words stored by the quantity storing unit 24 (step S901).

Subsequently, the web-page sorting unit 33 determines whether the number of matching words stored by the quantity storing unit 24 is equal to or larger than the specified threshold value (step S902). When the number of matching words that has been stored is equal to or larger than the threshold value (Step S902: Yes), the web page is sorted as an advertisement page (step S903), and the web-page sorting processing terminates. When the number of matching words that has been stored is smaller than the threshold value (step S902: No), the web page is sorted as a non-advertisement page (step S904), and the web-page sorting processing terminates.

In the web-page sorting apparatus 10, the web-page sorting unit 33 sorts out the advertisement pages based on the determination described above, because it is considered that the text information included in advertisement pages contain a large number of words that include unique expressions. Accordingly, when the number of words including unique expressions on a web page is equal to or larger than the predetermined threshold value, the web page is sorted as an advertisement page. In the description of the first embodiment, the example in which the determination is made using the threshold value is explained. However, the present invention is not limited to this example. It is acceptable to use any other methods as long as the advertisement pages are sorted out based on the number of words that has been counted. For example, the determination can be made not only based on the number of words that simply match, but also based on the number of words that match in a large number of various categories.

As explained above, the first embodiment provides a web-page sorting program that causes a computer to execute sorting out an advertisement page on which an article written by an advertiser is posted, from web pages used for posting articles on the Internet. In the sorting, the word list in which the words including unique expressions are registered is held. Words are extracted from the text information included in the web pages. The number of words that match between the words contained in the word list and the extracted words is counted. The advertisement pages are sorted out from the web pages based on the number of matching words. It is considered that the text information included in advertisement pages contains a large number of words that include unique expressions. Thus, for example, when the number of words including unique expression on a web page is equal to or larger than the specified threshold value, the web page is sorted as an advertisement page. Thus, compared to other methods of sorting out advertisement pages in which the person who extracts reputation information needs to specify the URLs, this method makes it possible to sort out advertisement pages more easily. Accordingly, it is possible to sort out advertisement pages appropriately without lowering the degree of precision in the results of the analysis obtained by extracting and analyzing the reputation information from the web pages, even though the Internet requires that a huge amount of information be covered thoroughly and also that the information, which is updated daily, be followed up immediately.

In addition, according to the first embodiment, the word list in which the words including unique expressions in a large number of categories are registered is held; and the number of words that match, in a large number of categories, between the words contained in the word list and the extracted words is counted. Thus, it is possible to sort out the web pages that contain unique expressions that are used in the large number of categories as the text information, as advertisement pages.

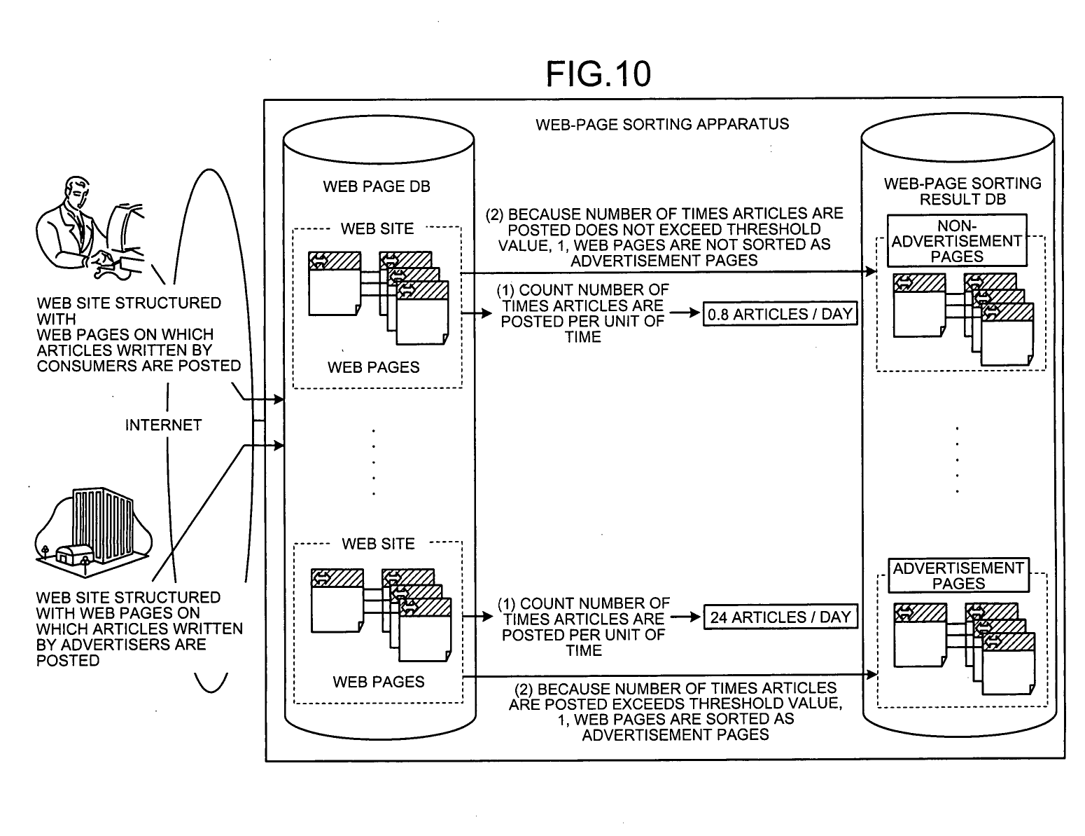

FIG. 10 is a schematic for explaining the concept and the characteristics of a web-page sorting apparatus according to a second embodiment of the present invention. In the following section, web pages structuring a web site are used as the targets of the sorting process; and also, the web pages structuring a web site that does not require the creator of the web site to be conscious of HTMLs are used as the targets of the sorting process.

The concept of the web-page sorting apparatus according to the second embodiment can be summarized as the function of sorting out advertisement pages on which articles written by the advertisers are posted, from the web pages that structure a web site and are used for posting articles in a chronological order on the Internet. The principal characteristics of the web-page sorting apparatus according to the second embodiment can be summarized as follows: Compared to other methods of sorting out advertisement pages in which the person who extracts reputation information needs to specify the URLs, this method makes it possible to sort out advertisement pages more easily. It is possible to sort out advertisement pages appropriately without lowering the degree of precision in the results of the analysis obtained by extracting and analyzing the reputation information from the web pages, even though the Internet requires that a huge amount of information be covered thoroughly and also that the information, which is updated daily, be followed up immediately.

To explain the principal characteristics briefly, as shown in FIG. 10, the web-page sorting apparatus according to the second embodiment stores therein, in advance, the web pages that are used as the targets of the sorting process, like in the first embodiment.

Firstly, the web-page sorting apparatus according to the second embodiment counts the number of times articles are posted on the web pages that structure a single web site, per predetermined unit time (See (1) in FIG. 10). For example, when the predetermined unit time is one day, the number of times articles are posted per day is counted as 0.8 articles or 24 articles.

Next, the web-page sorting apparatus sorts out advertisement pages from the web pages, based on the counted number of times articles are posted (See (2) in FIG. 10.) For example, the web-page sorting apparatus according to the second embodiment sets a threshold value to 1. When the counted number of times articles are posted is equal to or larger than the threshold value, it is determined that the web pages will be sorted as advertisement pages. When the counted number of times articles are posted is smaller than the threshold value, it is determined that the web pages will not be sorted as advertisement pages (i.e. the web pages will be sorted as non-advertisement pages). In other words, it is considered that it is possible to post a large number of articles constantly on advertisement pages, due to the fact that the articles are automatically posted on the advertisement pages. Thus, for example, when the number of times articles are posted on web pages is equal to or larger than the specified threshold value, the web pages are sorted as advertisement pages. In the example shown in FIG. 10, the web-page sorting apparatus sorts out the web pages of which the number of times articles are posted is 0.8 articles per day as non-advertisement pages, because the number is smaller than the threshold value of 1. Also, the web-page sorting apparatus sorts out the web pages of which the number of times articles are posted is 24 articles per day as advertisement pages, because the number is larger than the threshold value of 1.

With the above arrangement, when the web-page sorting apparatus according to the second embodiment is used, it is possible to sort out the advertisement pages more easily, compared to other methods of sorting out advertisement pages in which the person who extracts reputation information needs to specify the URLs. Thus, it is possible to sort out the advertisement pages appropriately without lowering the degree of precision in the results of the analysis obtained by extracting and analyzing the reputation information from the web pages, even though the Internet requires that a huge amount of information be covered thoroughly and also that the information, which is updated daily, be followed up immediately.

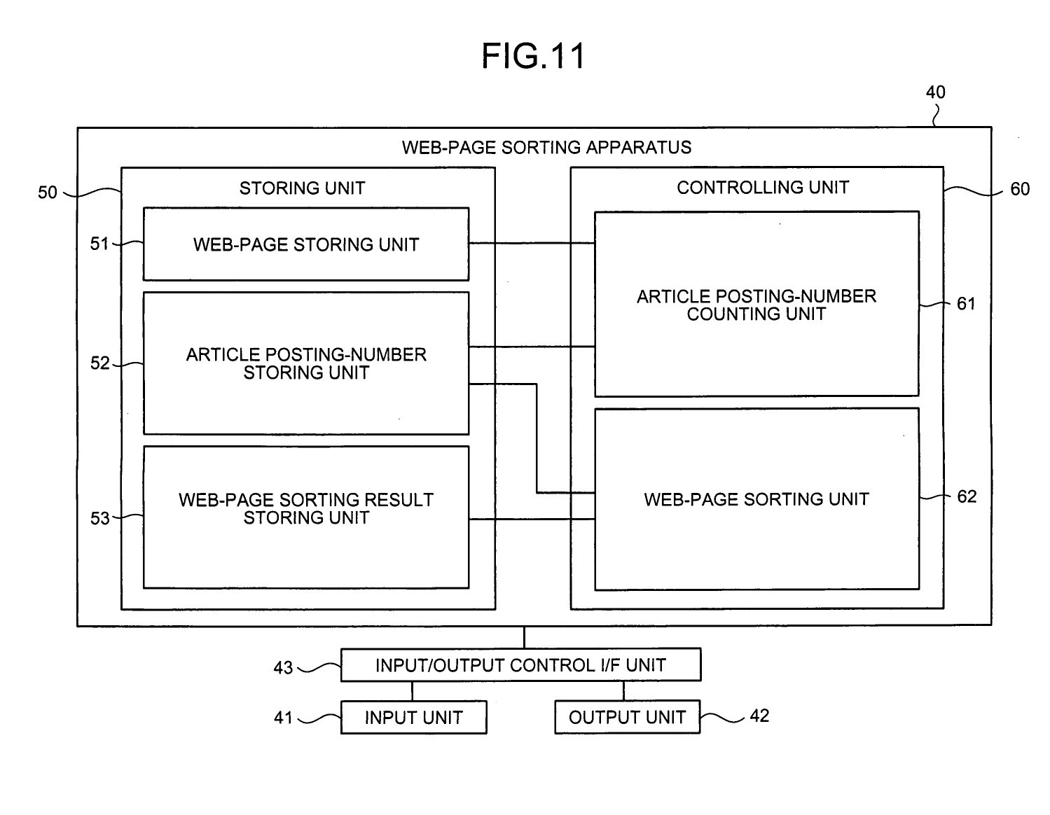

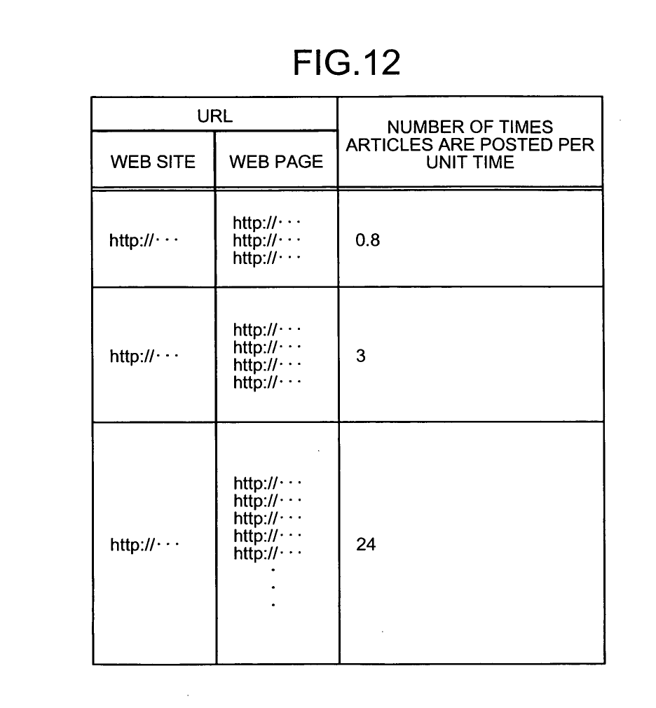

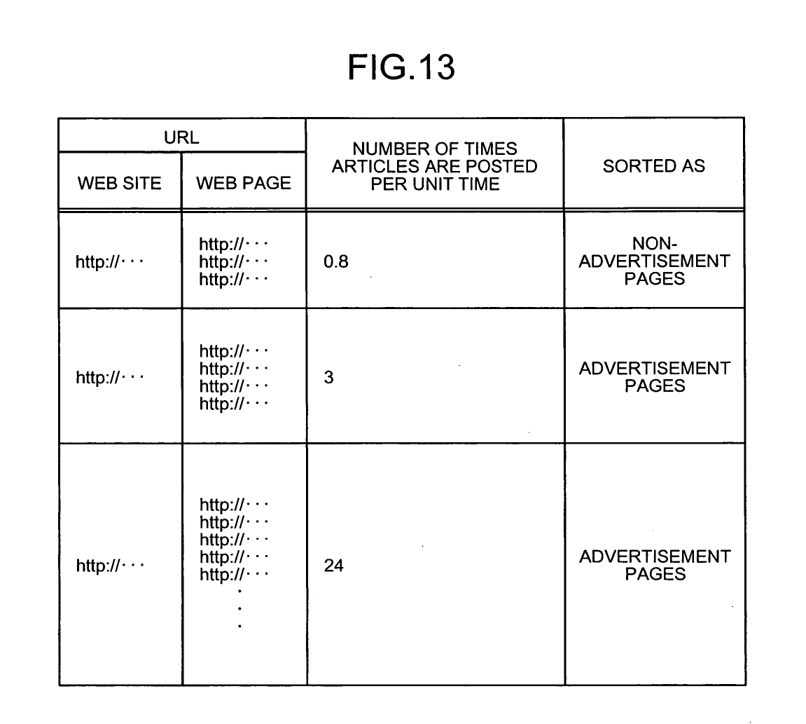

Next, the configuration of the web-page sorting apparatus according to the second embodiment will be explained, with reference to FIGS. 11 to 13. FIG. 11 is a block diagram of a web-page sorting apparatus 40 according to the second embodiment. FIG. 12 is a table for explaining the contents of an article posting-number storing unit 52 shown in FIG. 11. FIG. 13 is a table for explaining the contents of a web-page sorting result storing unit 53 shown in FIG. 11.

As shown in FIG. 11, the web-page sorting apparatus 40 includes an input unit 41, an output unit 42, an input/output control I/F unit 43, a storing unit 50, and a control unit 60.

The input unit 41 is an input unit used for inputting the data that is used in various types of processing performed by the control unit 60 and the operation instructions for performing various types of processing, with a keyboard, a storage medium, or through communications. To be more specific, the input unit 41 inputs the web pages that structure a single web site and are used for posting articles in a chronological order on the Internet, collectively as one group of web pages that structure the single web site, and stores the group of web pages into a web-page storing unit 51.

The output unit 42 is an output unit that outputs the results of various types of processing performed by the control unit 60 and the operation instructions for performing various types of processing to a monitor, a printer, or the like.

The input/output control I/F unit 43 is a unit that controls the data transfer between the input unit 41 and the output unit 42; and between the storing unit 50 and the control unit 60.

The storing unit 50 stores therein the data used in various types of processing performed by the control unit 60. In particular, the storing unit 50 includes the web-page storing unit 51, the article posting-number storing unit 52, and the web-page sorting result storing unit 53.

The web-page storing unit 51 stores therein the web pages that are used as the targets of the sorting process performed by the web-page sorting apparatus 40 and that structure a single web site. To be more specific, the web-page storing unit 51 stores therein the web pages that have been input by the input unit 41, collectively as a group of web pages that structure the single web site.

The article posting-number storing unit 52 stores therein the number of times articles are posted on the web pages that are used as the targets of the sorting process performed by the web-page sorting apparatus 40 and that structure a single web site. To be more specific, the article posting-number storing unit 52 stores therein the number of times articles are posted on the web pages that are stored in the web-page storing unit 51, the number of times being counted by an article posting-number counting unit 61. For example, as shown in FIG. 12, the article posting-number storing unit 52 stores therein URLs of the web pages that structure the web sites, and the number of times articles are posted per unit time, while associating them one another.

The web-page sorting result storing unit 53 stores therein the results of the sorting process to sort out advertisement pages from the web pages, performed by the web-page sorting apparatus 40. To be more specific, the web-page sorting result storing unit 53 stores therein the results obtained through the sorting process to sort out the advertisement pages from the web pages, performed by a web-page sorting unit 62. For example, as shown in FIG. 13, the web-page sorting result storing unit 53 stores therein URLs of the web pages that structure the web sites, and the number of times articles are posted per unit time, and the results of the sorting process (non-advertisement pages or advertisement pages), while associating them one another. According to the second embodiment, the threshold value is set to 1, for example. When the number of times articles are posted that has been counted is equal to or larger than 1, it is determined that the web site (i.e. the web pages that structure the single web site) will be sorted as advertisement pages. When the number of times articles are posted that has been counted is smaller than 1, it is determined that the web site will not be sorted as advertisement pages (i.e. the web site will be sorted as non-advertisement pages).

Returning to the explanation of FIG. 11, the control unit 60 controls the web-page sorting apparatus 40 so that various types of processing are performed. In particular, the control unit 60 includes the article posting-number counting unit 61 and the web-page sorting unit 62.

The article posting-number counting unit 61 counts the number of times articles are posted on the web pages that structure a single web site per predetermined unit time. To be more specific, the article posting-number counting unit 61 counts the number of times articles are posted on the web pages that are stored in the web-page storing unit 51 and that structure the single web site, per predetermined unit time and stores the counted number of times into the article posting-number storing unit 52. The specific processing performed by the article posting-number counting unit 61 will be explained in detail in the description of the processing performed by the web-page sorting apparatus according to the second embodiment later.

The web-page sorting unit 62 sorts out advertisement pages from the web pages, based on the number of times articles are posted that has been counted. To be more specific, the web-page sorting unit 62 sorts out the advertisement pages from the web pages, based on the number of times articles are posted that has been stored in the article posting-number storing unit 52 and stores the result of the sorting process into the web-page sorting result storing unit 53. The specific processing performed by the web-page sorting unit 62 will be explained in detail in the description of the processing performed by the web-page sorting apparatus according to the second embodiment later.

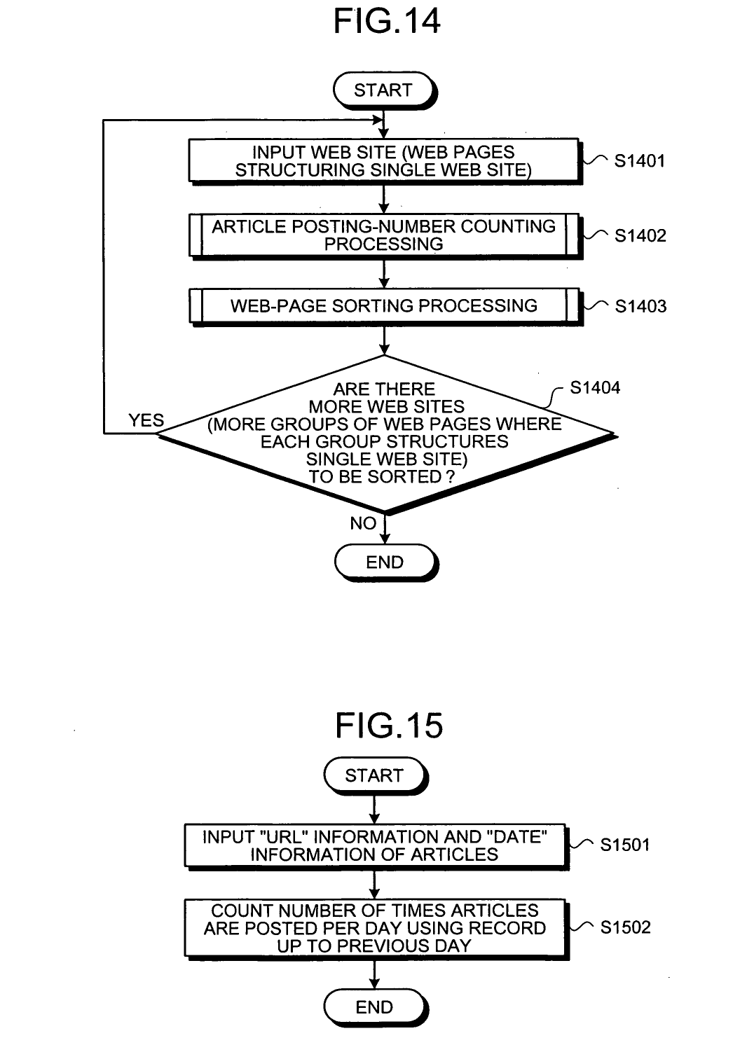

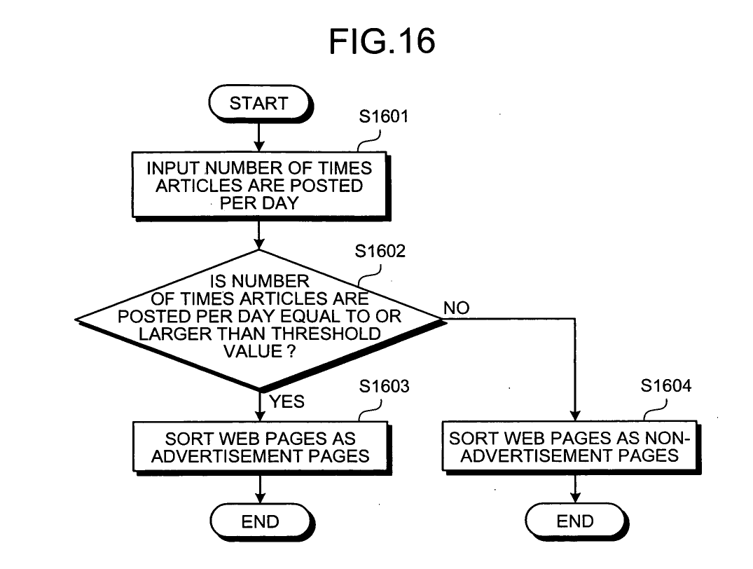

Next, the processing performed by the web-page sorting apparatus 40 will be explained with reference to FIGS. 14 to 16. FIG. 14 is a flowchart of the processing performed by the web-page sorting apparatus 40. FIG. 15 is a flowchart of an article posting-number counting processing shown in FIG. 14. FIG. 16 is a flowchart of a web-page sorting processing shown in FIG. 14.

As shown in FIG. 14, the article posting-number counting unit 61 receives an input of a web site that is to be used as the target of the sorting process, from the web-page storing unit 51 (step S1401). In this situation, more specifically, the web site denotes a group of web pages that structure a single web site. When sorting through the web pages, the web-page sorting apparatus 40 uses, collectively all at the same time, the group of web pages that structure the single web site as the target of the sorting process.

Next, the article posting-number counting unit 61 counts the number of times articles are posted on the web pages that have been received as the input and that structure the single web site, so that the counted number of times is stored into the article posting-number storing unit 52 (step S1402).

Then, the web-page sorting unit 62 sorts out advertisement pages, based on the number of times articles are posted that has been stored by the article posting-number storing unit 52, so that the result of the sorting process is stored into the web-page sorting result storing unit 53 (step S1403).

Next, the web-page sorting apparatus 40 determines whether there exist other web sites (i.e. groups of web pages where each group structures a single web site) that are to be used as the targets of the sorting process (step S1404). When there exist other web sites that are to be used as the targets of the sorting process (step S1404: Yes), the process control returns to step S1401. On the other hand, when there exist no other web sites that are to be used as the targets of the sorting process (step S1404: No), the web-page sorting apparatus 40 terminates the processing.

Next, the article-posing-number counting processing at step S1402 in FIG. 14 will be explained in detail. As shown in FIG. 15, the article posting-number counting unit 61 receives an input of the “URL” information and the “date” information of the articles posted in a chronological order on the web pages structuring the web site that has been received as the input (step S1501).

Then, the article posting-number counting unit 61 counts the number of times article have been posted, using the record up to the previous day. The article posting-number counting unit 61 then calculates the number of times articles are posted per day, by dividing the number of times articles have been posted by the number of days in the counting (step S1502); and, the article posting-number counting processing terminates. In the second embodiment, the example in which the number of times articles are posted per day is calculated is explained. However, the present invention is not limited to this example; therefore it is acceptable to use any other method to calculate the number of times articles are posted. For example, it is acceptable to calculate the number of times articles are posted per month or per 12 hours.

Next, the web-page sorting processing at step S1403 in FIG. 14 will be explained in detail. As shown in FIG. 16, the web-page sorting unit 62 receives an input of the number of times articles are posted per day, which is stored by the article posting-number storing unit 52 (step S1601).

Subsequently, the web-page sorting unit 62 determines whether the number of times articles are posted that has been stored by the article posting-number storing unit 52 is equal to or larger than the predetermined threshold value (step S1602). When the number of times that has been stored is equal to or larger than the threshold value (Step S1602: Yes), the web-page sorting unit 62 sorts the web pages as advertisement pages (step S1603), and the web-page sorting processing terminates. When the number of times that has been stored is smaller than the threshold value (step S1602: No), the web-page sorting unit 62 sorts the web pages as non-advertisement pages (step S1604), and sorting processing terminates.

The web-page sorting unit 62 sorts the advertisement pages based on the judgment described above, because it is considered that it is possible to post a large number of articles constantly on advertisement pages, due to the fact that the articles are automatically posted on the advertisement pages. Accordingly, when the number of times articles are posted on web pages is equal to or larger than the predetermined threshold value, the web pages are sorted as advertisement pages. In the description of the second embodiment, the example in which the determination is made using the threshold value is explained. However, the present invention is not limited to this example. It is acceptable to use any other methods as long as the advertisement pages are sorted based on the number of times articles are posted. For example, the determination can be made based on the fluctuation tendency of the number of times articles are posted.

As explained above, the second embodiment provides a web-page sorting program that causes a computer to execute sorting out an advertisement page on which an article written by an advertiser is posted, from web pages that are used for posting articles in a chronological order on the Internet and that structure web sites. In this method, the number of times articles are posted on the web pages that structure a single web site is counted, and the advertisement pages are sorted out from the web pages based on the number of times articles are posted that has been counted. It is considered that it is possible to post a large number of articles constantly on advertisement pages, due to the fact that the articles are automatically posted on the advertisement pages. Accordingly, when the number of times articles are posted on web pages is equal to or larger than the specified threshold value, the web pages are sorted as advertisement pages. Thus, compared to other methods of sorting out advertisement pages in which the person who extracts reputation information needs to specify the URLs, this method makes it possible to sort out advertisement pages more easily. Accordingly, it is possible to sort out advertisement pages appropriately without lowering the degree of precision in the results of the analysis obtained by extracting and analyzing the reputation information from the web pages, even though the Internet requires that a huge amount of information be covered thoroughly and also that the information, which is updated daily, be followed up immediately.

In addition, as explained above, according to the second embodiment, the number of times articles are posted is counted per predetermined unit time. Thus, it is possible to sort out the advertisement pages based on the tendency shown by the number of times articles are posted per unit time.

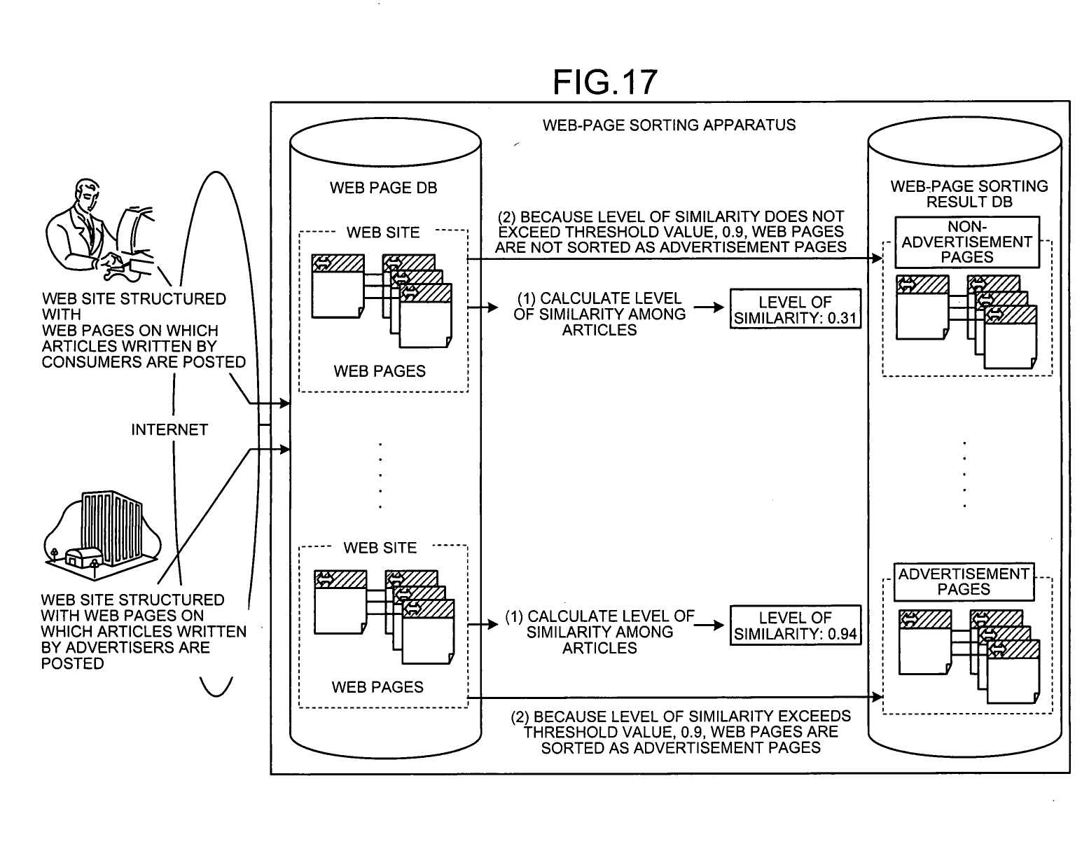

FIG. 17 is a schematic for explaining the concept and the characteristics of a web-page sorting apparatus according to a third embodiment of the present invention. In the following section, web pages structuring a web site are used as the targets of the sorting process; and also the web pages structuring a web site that does not require the creator of the web site to be conscious of HTMLs are used as the targets of the sorting process.

The overview of the web-page sorting apparatus according to the third embodiment can be summarized as the function of sorting out the advertisement pages on which articles written by the advertisers are posted, from the web pages that structure a web site and are used for posting articles in a chronological order on the Internet. The principal characteristics of the web-page sorting apparatus according to the third embodiment can be summarized as follows: Compared to other methods of sorting out advertisement pages in which the person who extracts reputation information needs to specify the URLs, this method makes it possible to sort out advertisement pages more easily. It is possible to sort out advertisement pages appropriately without lowering the degree of precision in the results of the analysis obtained by extracting and analyzing the reputation information from the web pages, even though the Internet requires that a huge amount of information be covered thoroughly and also that the information, which is updated daily, be followed up immediately.

To explain the principal characteristics briefly, as shown in FIG. 17, the web-page sorting apparatus according to the third embodiment stores therein, in advance, the web pages that are used as the targets of the sorting process, like in the first and the second embodiments.

Firstly, the web-page sorting apparatus according to the third embodiment calculates the level of similarity among the plurality of articles that are posted on the web pages that structure a single web site (See (1) in FIG. 17). For example, the web-page sorting apparatus calculates the level of similarity in the contents among the articles as 0.31 or 0.94, as shown in FIG. 17.

Next, the web-page sorting apparatus sorts out advertisement pages from the web pages, based on the calculated level of similarity (See (2) in FIG. 17.) For example, the web-page sorting apparatus according to the third embodiment sets a threshold value to 0.9. When the calculated level of similarity is equal to or larger than the threshold value, it is determined that the web pages will be sorted as advertisement pages. When the calculated level of similarity is smaller than the threshold value, it is determined that the web pages will not be sorted as advertisement pages (i.e. the web pages will be sorted as non-advertisement pages). In other words, it is considered that the level of similarity among the articles in a web site structured with advertisement pages is high, due to the fact that the articles are written using a template. Thus, for example, when a group of web pages has a level of similarity that is equal to or higher than the predetermined threshold value, the group of web pages is sorted as advertisement pages. In the example shown in FIG. 17, the web-page sorting apparatus sorts out the web pages in which the level of similarity in terms of the contents is 0.31 as non-advertisement pages, because the level of similarity is smaller than the threshold value of 0.9. Also, the web-page sorting apparatus sorts out the web pages in which the level of similarity in terms of the contents is 0.94 as advertisement pages, because the level of similarity is larger than the threshold value of 0.9.

With this arrangement, when the web-page sorting apparatus according to the third embodiment is used, it is possible to sort out the advertisement pages more easily, compared to other methods of sorting out advertisement pages in which the person who extracts reputation information needs to specify the URLs. Thus, it is possible to sort out the advertisement pages appropriately without lowering the degree of precision in the results of the analysis obtained by extracting and analyzing the reputation information from the web pages, even though the Internet requires that a huge amount of information be covered thoroughly and also that the information, which is updated daily, be followed up immediately.

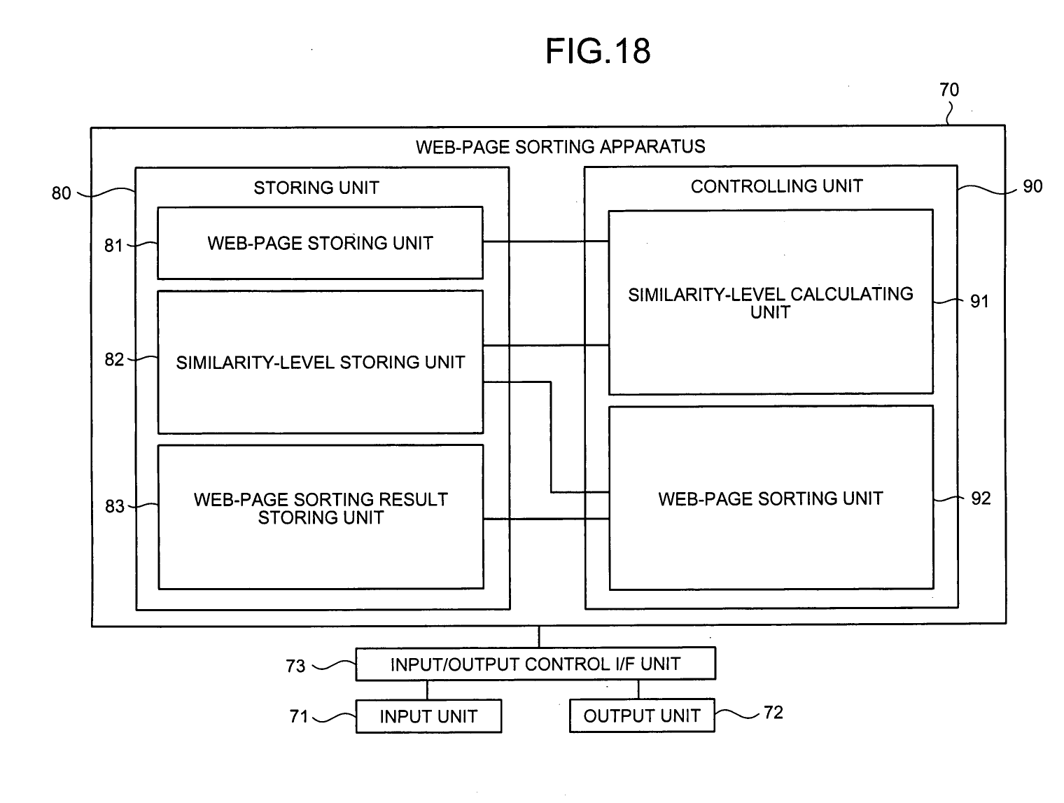

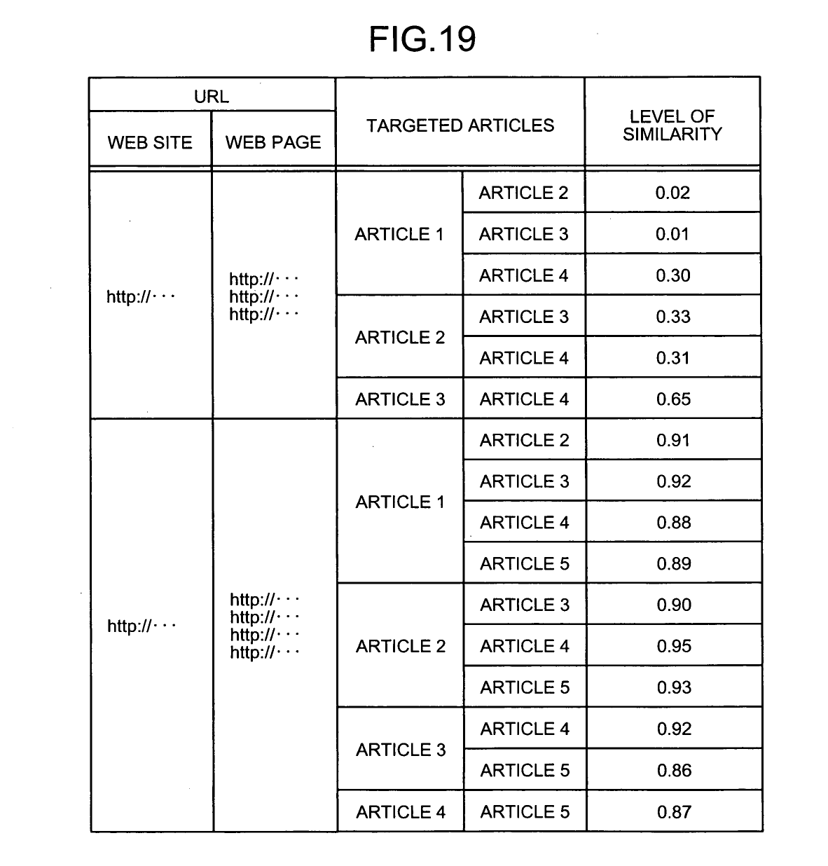

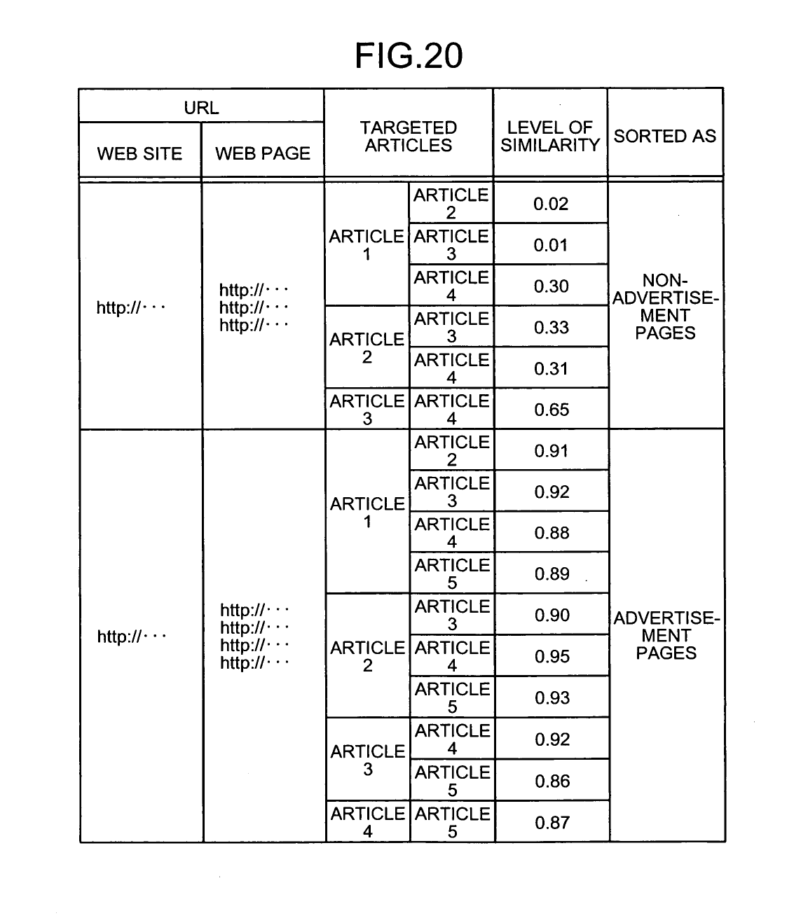

Next, the configuration of the web-page sorting apparatus according to the third embodiment will be explained with reference to FIGS. 18 to 20. FIG. 18 is a block diagram of a web-page sorting apparatus 70 according to the third embodiment. FIG. 19 is a drawing for explaining the contents of a similarity-level storing unit 82 shown in FIG. 18. FIG. 20 is a drawing for explaining the contents of a web-page sorting result storing unit 83 shown in FIG. 18.

As shown in FIG. 18, the web-page sorting apparatus 70 includes an input unit 71, an output unit 72, an input/output control I/F unit 73, a storing unit 80, and a control unit 90.

The input unit 71 is used for inputting data that is used in various types of processing performed by the control unit 90 and the operation instructions for performing various types of processing, with a keyboard, a storage medium, or through communications.

The output unit 72 is an output unit that outputs the results of various types of processing performed by the control unit 90 and the operation instructions for performing various types of processing to a monitor, a printer, or the like.

The input/output control I/F unit 73 is a unit that controls the data transfer between the input unit 71 with the output unit 72 and the storing unit 80 with the control unit 90.

The storing unit 80 stores therein the data used in various types of processing performed by the control unit 90. In particular, the storing unit 80 includes, as shown in FIG. 18, a web-page storing unit 81, the similarity-level storing unit 82, and the web-page sorting result storing unit 83.

The web-page storing unit 81 stores therein the web pages that are used as the targets of the sorting process performed by the web-page sorting apparatus 70 and that structure a single web site, like the web-page storing unit 51 according to the second embodiment.

The similarity-level storing unit 82 stores therein the level of similarity among a plurality of articles posted on the web pages that are used as the targets of the sorting process performed by the web-page sorting apparatus 70 and that structure a single web site. To be more specific, the similarity-level storing unit 82 stores therein the level of similarity among the articles posted on the web pages that are stored in the web-page storing unit 81 and that structure a single web site, the level of similarity being calculated by a similarity-level calculating unit 91. For example, as shown in FIG. 19, the similarity-level storing unit 82 stores therein the URLs of the web pages that structure the web sites, and the levels of similarity among the articles that are posted on the web pages, while associating them with one another.

The web-page sorting result storing unit 83 stores therein the results of the sorting process to sort out advertisement pages from the web pages, performed by the web-page sorting apparatus 70. To be more specific, the web-page sorting result storing unit 83 stores therein the results obtained through the sorting process to sort out the advertisement pages from the web pages, performed by a web-page sorting unit 92. For example, as shown in FIG. 20, the web-page sorting result storing unit 83 stores therein URLs of the web pages that structure the web sites, and the levels of similarity among the articles posted on the web pages, and the results of the sorting process (non-advertisement pages or advertisement pages), while keeping them in correspondence with one another. According to the third embodiment, the threshold value is set to 0.9, for example. When at least one of the levels of similarity that have been calculated is equal to or larger than 0.9, it is determined that the web site (i.e. the web pages that structure the single web site) will be sorted as advertisement pages. When all of the levels of similarity that have been calculated are smaller than 0.9, it is determined that the web site will not be sorted as advertisement pages (i.e. the web site will be sorted as non-advertisement pages).

Returning to the explanation of FIG. 18, the control unit 90 controls the web-page sorting apparatus 70 so that various types of processing are performed. In particular, the control unit 90 includes, as shown in FIG. 18, the similarity-level calculating unit 91 and the web-page sorting unit 92. The similarity-level calculating unit 91 is a unit with which the web-page sorting apparatus 70 calculates the level of similarity in terms of the contents among the articles that are posted on the web pages that structure a single web site. To be more specific, the similarity-level calculating unit 91 calculates the level of similarity in terms of the contents among the articles posted on the web pages that are stored in the web-page storing unit 81 and that structure the single web site and stores the calculated level of similarity into the similarity-level storing unit 82. The specific processing performed by the similarity-level calculating unit 91 will be explained in detail in the description of the processing performed by the web-page sorting apparatus 70.

The web-page sorting unit 92 sorts out advertisement pages from the web pages, based on the calculated level of similarity. To be more specific, the web-page sorting unit 92 sorts out the advertisement pages from the web pages, based on the level of similarity that has been stored in the similarity-level storing unit 82 and stores the result of the sorting process into the web-page sorting result storing unit 83. The specific processing performed by the web-page sorting unit 92 will be explained in detail in the description of the processing performed by the web-page sorting apparatus 70.

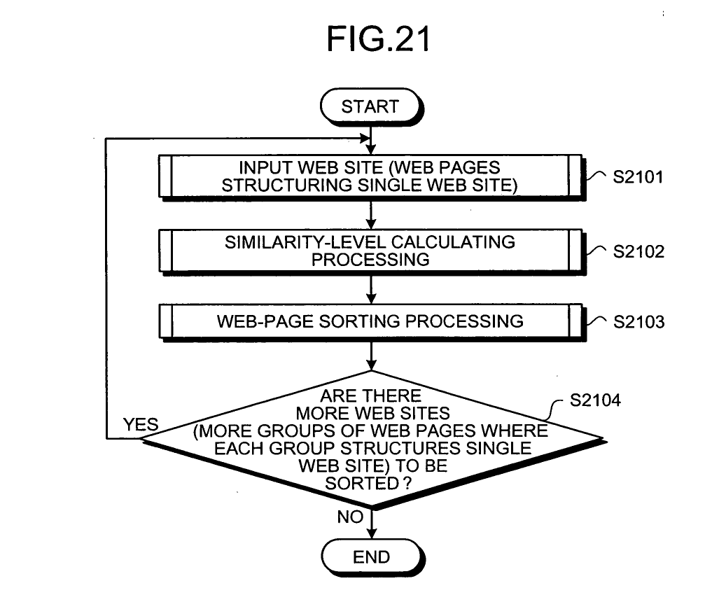

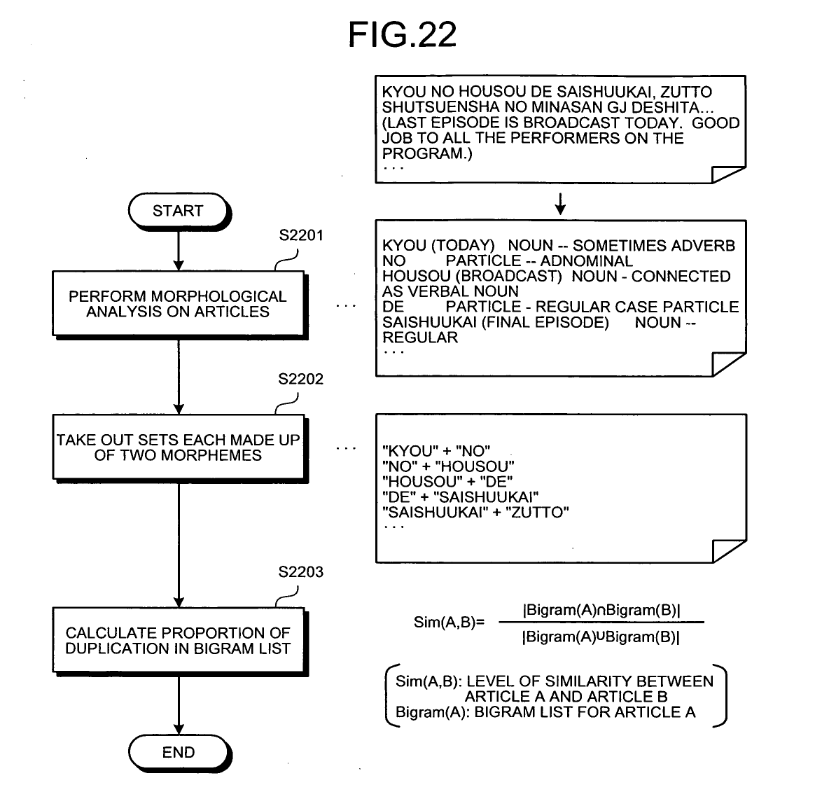

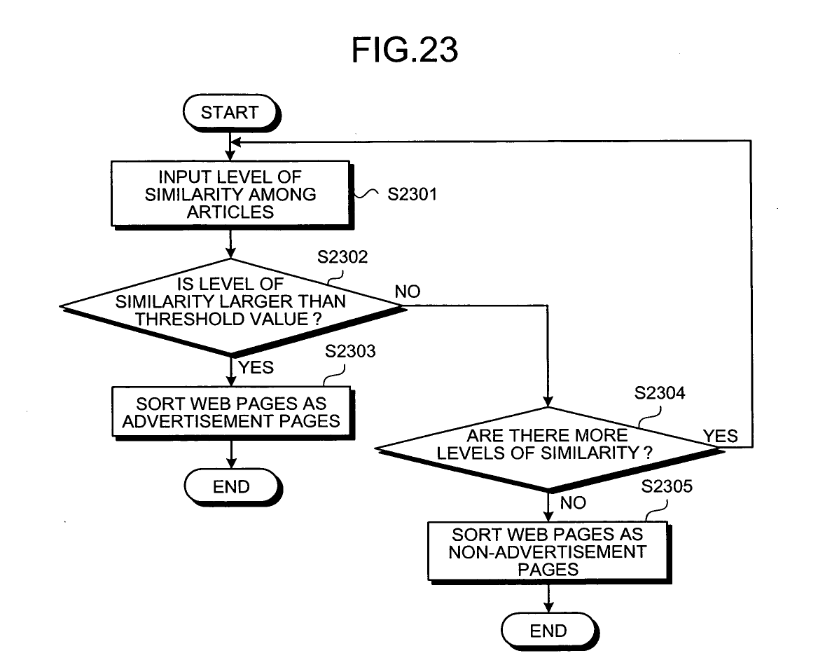

Next, the processing performed by the web-page sorting apparatus 70 will be explained with reference to FIGS. 21 to 23. FIG. 21 is a flowchart of the processing performed by the web-page sorting apparatus 70. FIG. 22 is a flowchart of a similarity-level calculating processing shown in FIG. 20. FIG. 23 is a flowchart of a web-page sorting processing shown in FIG. 20.

As shown in FIG. 21, the similarity-level calculating unit 91 receives an input of a web site that is to be used as the target of the sorting process, from the web-page storing unit 81 (step S2101). In this situation, more specifically, the web site denotes a group of web pages that structure a single web site. When sorting through the web pages, the web-page sorting apparatus 70 uses, collectively at the same time, the group of web pages that structure the single web site as the target of the sorting process.

Next, the similarity-level calculating unit 91 calculates the level of similarity among the articles posted on the web pages that have been received as the input and that structure the single web site, so that the calculated level of similarity is stored into the similarity-level storing unit 82 (step S2102).

Then, the web-page sorting unit 92 sorts out advertisement pages, based on the level of similarity that has been stored by the similarity-level storing unit 82, so that the result of the sorting process is stored into the web-page sorting result storing unit 83 (step S2103).

Next, the web-page sorting apparatus 70 determines whether there exist other web sites (i.e. groups of web pages where each group structures a single web site) that are to be used as the targets of the sorting process (step S2104). When there exist other web sites that are to be used as the targets of the sorting process (step S2104: Yes), the procedures returns to the step at which the similarity-level calculating unit 91 receives an input of a web site to be used as the target of the sorting process, from the web-page storing unit 81 (step S2101). On the other hand, when there exist no other web sites that are to be used as the targets of the sorting process (step S2104: No), the web-page sorting apparatus 70 terminates the processing.

Next, the similarity-level calculating processing at step S2102 in FIG. 21 will be explained in detail. As shown in FIG. 22, the similarity-level calculating unit 91 performs a morphological analysis on the articles that are posted in a chronological order on the web pages that have been received as the input (step S2201). In other words, the text information that is written in a natural language is divided into morphemes (each of which is the smallest unit that can carry meaning in a language), and the parts of speech are identified. For example, the text information is divided into the morphemes such as “kyou (today)”, “no”, “housou (broadcast)”, “de”, and “saishuukai (final episode)”.

Subsequently, the similarity-level calculating unit 91 takes out sets each made up of two morphemes from the morphemes into which the text information is divided at Step S2201 (step S2202). For example, the similarity-level calculating unit 91 takes out the sets that are each made up of: “kyou” and “no”, “no” and “housou”, “housou” and “de”, “de” and “saishuukai”, “saishuukai” and “zutto” and so on. The list of these sets that have been taken out is called a bigram list.

Then, the similarity-level calculating unit 91 calculates the proportion of duplication in the bigram list (step S2203), and the similarity-level calculating processing terminates. To be more specific, the calculating formula that is used for calculating the level of similarity between the article A and the article B based on the proportion of duplication in the bigram list is expressed as a fraction in which the denominator is the sum of the number of elements in the bigram list for the article A and the bigram list for the article B, whereas the numerator is the number of elements that are duplicated between the bigram list for the article A and the bigram list for the article B, as shown in FIG. 22. When the bigram list for the article A is completely identical to the bigram list for the article B, the level of similarity is 1. When the bigram list for the article A is completely different from the bigram list for the article B, the level of similarity is 0. In the description of the third embodiment, the example in which the levels of similarity are calculated using the bigram lists is explained. However, the present invention is not limited to this example. It is acceptable to use any method as long as it is possible to calculate the levels of similarity.

Next, the web-page sorting processing at step S2103 in FIG. 21 will be explained in detail. As shown in FIG. 23, the web-page sorting unit 92 receives an input of the level of similarity among the articles, which is stored by the similarity-level storing unit 82 (step S2301).

Subsequently, the web-page sorting unit 92 determines whether the level of similarity that has been stored by the similarity-level storing unit 82 is equal to or larger than the specified threshold value (step S2302). When the level of similarity that has been stored is equal to or larger than the threshold value (Step S2302: Yes), the web-page sorting unit 92 sorts the web pages as advertisement pages (step S2303), and the web-page sorting processing terminates. When the level of similarity that has been stored is smaller than the threshold value (step S2302: No), it is determined whether there exist other levels of similarity that should go through the judgment process (step S2304). If there exist other levels of similarity that should go through the determination process (step S2304: Yes), the procedure performed by the web-page sorting apparatus 70 returns to step S2301. If there exist no other levels of similarity that should go through the determination process (step S2304: No), the web pages are sorted as non-advertisement pages (step S2305), and the web-page sorting processing terminates.

The web-page sorting unit 92 sorts the advertisement pages based on the determination described above, because it is considered that the level of similarity among the articles in a web site structured with advertisement pages is high, due to the fact that the articles are written using a template. Accordingly, when a group of web pages has a level of similarity that is equal to or higher than the threshold value, the group of web pages is sorted as advertisement pages. In the description of the third embodiment, the example in which, when at least one of the levels of similarity that have been calculated is equal to or larger than the threshold value, the group of web pages is sorted as advertisement pages is explained. However, the present invention is not limited to this example. It is acceptable to use any other methods as long as the web pages are sorted based on the calculated levels of similarity. For example, the judgment may be made based on whether an average of the calculated levels of similarity is equal to or larger than the threshold value.

As explained above, the third embodiment provides a web-page sorting program that causes a computer to execute sorting out an advertisement page on which an article written by an advertiser is posted, from web pages that are used for posting articles in a chronological order on the Internet and that structure web sites. In this method, the level of similarity among the articles posted on the web pages that structure a single web site is calculated, and the advertisement pages are sorted out from the web pages based on the calculated level of similarity. It is considered that the level of similarity among the articles in a web site structured with advertisement pages is high, due to the fact that the articles are written using a template. Accordingly, when a group of web pages has a level of similarity that is equal to or higher than the predetermined threshold value, the group of web pages is sorted as advertisement pages. Thus, compared to other methods of sorting out advertisement pages in which the person who extracts reputation information needs to specify the URLs, this method makes it possible to sort out advertisement pages more easily. Thus, it is possible to sort out advertisement pages appropriately without lowering the degree of precision in the results of the analysis obtained by extracting and analyzing the reputation information from the web pages, even though the Internet requires that a huge amount of information be covered thoroughly and also that the information, which is updated daily, be followed up immediately.

In addition, according to the third embodiment, because the levels of similarity in terms of the contents among the articles are calculated, it is possible to sort out the advertisement pages based on the tendency shown by the levels of similarity in terms of the contents among the articles.

So far, the web-page sorting apparatuses according to the first to the third embodiments have been explained. However, the present invention can be applied to other various embodiments besides the exemplary embodiments described above. In the following sections, other exemplary embodiments will be explained as a web-page sorting apparatus.

In the description of the first embodiment, the example is explained where the word list in which the words including unique expressions in a large number of categories are registered is held. However, the present invention is not limited to this example. The present invention is applicable likewise to a case where a word list in which words including unique expressions in only one category are registered is held.

In the description of the second embodiment, the example in which the number of times articles are posted per predetermined unit of time is counted is explained. However, the present invention is not limited to this example. The present invention is applicable likewise to a case where the number of times articles are posted is counted for each day of the week for one or more weeks or a case where the number of times articles are posted is counted for each of predetermined time slots. When the number of times articles are posted is counted for each day of the week for one or more weeks, it is possible to sort out the advertisement pages based on the tendency shown by the number of times articles are posted for each day of the week. When the number of times articles are posted is counted for each of the predetermined time slots, it is possible to sort out advertisement pages based on the tendency shown by the number of times articles are posted for each of the predetermined time slots.

In the description of the third embodiment, the example in which the levels of similarity in terms of the contents among the articles are calculated is explained. However, the present invention is not limited to this example. The present invention is applicable likewise to a case where the levels of similarity in terms of the amounts of writing among the articles are calculated. When the levels of similarity in terms of the amounts of writing among the articles are calculated, it is possible to sort out the advertisement pages based on the tendency shown by the levels of similarity in terms of the amounts of writing among the articles.

In the description of the first to the third embodiments, the example in which a blog is used as a typical example of a web site that does not require the creators of the web sites to be conscious of HTMLs is explained. However, the present invention is not limited to this example. The present invention is applicable likewise as long as the web site is compatible with Resource Description Framework (RDF) Site Summary (RSS) in which the URL information and the date information of the articles are stored.

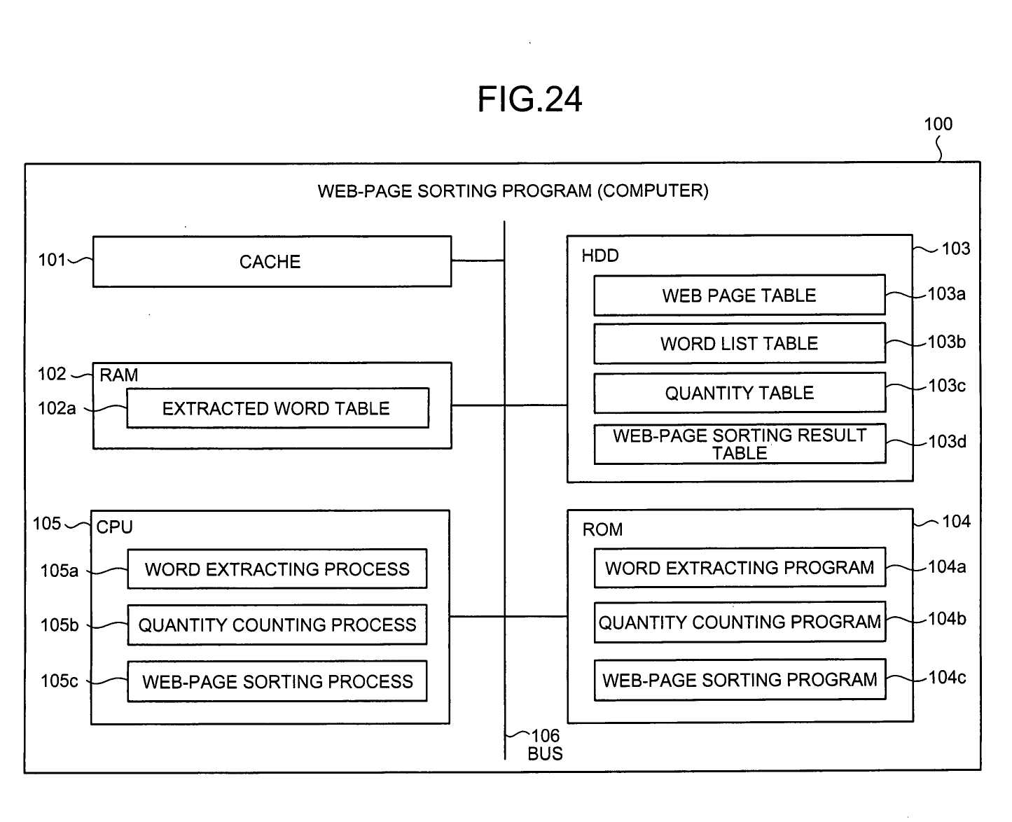

It is possible to realize the various types of processing explained in the description of the first embodiment by causing a computer, such as a personal computer or a work station, to execute a computer program (hereinafter, “web-page sorting program”) that is prepared in advance. In the following sections, an example of a computer that executes the web-page sorting program having the same functions as in the first embodiment above will be explained with reference to FIG. 24. FIG. 24 is a drawing of the computer that executes the web-page sorting program in relation to the first embodiment.

As shown in FIG. 24, a computer 100 is configured so as to include a cache 101, a Random Access Memory (RAM) 102, a Hard Disk Drive (HDD) 103, a Read-Only Memory (ROM) 104, and a Central Processing Unit (CPU) 105 that are connected to one another with a bus 106. The ROM 104 stores therein, in advance, the web-page sorting program that achieves the same functions as in the first embodiment. In other words, as shown in FIG. 24, the ROM 104 stores therein a word extracting program 104a, a quantity counting program 104b, and a web-page sorting program 104c.

The CPU 105 reads and executes the programs 104a, 104b, and 104c. Accordingly, the programs 104a, 104b, and 104c become a word extracting process 105a, a quantity counting process 105b, and a web-page sorting process 105c. The processes 105a, 105b, and 105c correspond to the word extracting unit 31, the quantity counting unit 32, and the web-page sorting unit 33, that are shown in FIG. 2, respectively.

As shown in FIG. 24, included in the HDD 103 are a web page table 103a, a word list table 103b, a quantity table 103c, and a web-page sorting result table 103d. The tables 103a, 103b, 103c, and 103d correspond to the web-page storing unit 21, the word-list holding unit 23, the quantity storing unit 24, and the web-page sorting result storing unit 25, that are shown in FIG. 2, respectively.

As additional information, the programs 104a, 104b, and 104c do not necessarily have to be stored in the ROM 104. For example, it is acceptable to store the programs into a “portable physical medium” such as a Flexible Disk (FD), a Compact Disc Read Only Memory (CD-ROM), a Magneto Optical (MO) disk, a Digital Versatile Disk (DVD), or an Integrated Circuit (IC) card, that can be inserted into the computer 100, or a “stationary physical medium” such as a hard disk drive (HDD) that is provided on the inside or the outside of the computer 100, or “another computer (or a server)” that is connected to the computer 100 via a public circuit, the Internet, a Local Area Network (LAN), or a Wide Area Network (WAN). In these situations, the computer 100 reads the programs and executes the read program.

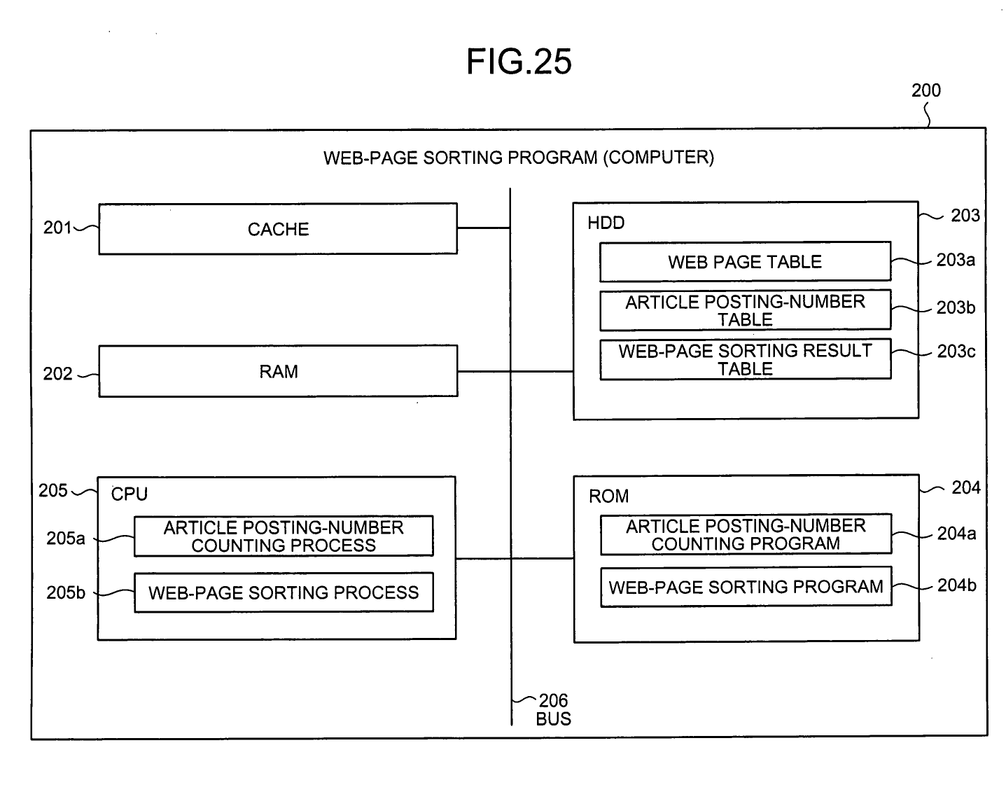

It is possible to realize the various types of processing explained in the description of the second embodiment by causing a computer, such as a personal computer or a work station, to execute a web-page sorting program that is prepared in advance. In the following sections, an example of a computer that executes the web-page sorting program having the same functions as in the second embodiment above will be explained, with reference to FIG. 25. FIG. 25 is a drawing of the computer that executes the web-page sorting program in relation to the second embodiment.

As shown in FIG. 25, a computer 200 is configured so as to include a cache 201, a RAM 202, an HDD 203, a ROM 204, and a CPU 205 that are connected to one another with a bus 206. The ROM 204 stores therein, in advance, the web-page sorting program that achieves the same functions as in the second embodiment. In other words, as shown in FIG. 25, the ROM 204 stores therein an article posting-number calculating program 204a and a web-page sorting program 204b.

The CPU 205 reads and executes the programs 204a and 204b. Accordingly, the programs 204a and 204b become an article posting-number counting process 205a and a web-page sorting process 205b. The processes 205a and 205b correspond to the article posting-number counting unit 61 and the web-page sorting unit 62, that are shown in FIG. 11, respectively.

As shown in FIG. 25, included in the HDD 203 are a web page table 203a, an article posting-number table 203b, and a web-page sorting result table 203c. The tables 203a, 203b, and 203c correspond to the web-page storing unit 51, the article posting-number storing unit 52, and the web-page sorting result storing unit 53, that are shown in FIG. 11, respectively.

As additional information, the programs 204a and 204b do not necessarily have to be stored in the ROM 204. For example, it is acceptable to store the programs into a “portable physical medium” such as a Flexible Disk (FD), a CD-ROM, an MO disk, a DVD, or an IC card, that can be inserted into the computer 200, or a “stationary physical medium” such as a hard disk drive (HDD) that is provided on the inside or the outside of the computer 200, or “another computer (or a server)” that is connected to the computer 200 via a public circuit, the Internet, a LAN, or a WAN. In these situations, the computer 200 reads the programs and executes the read programs.

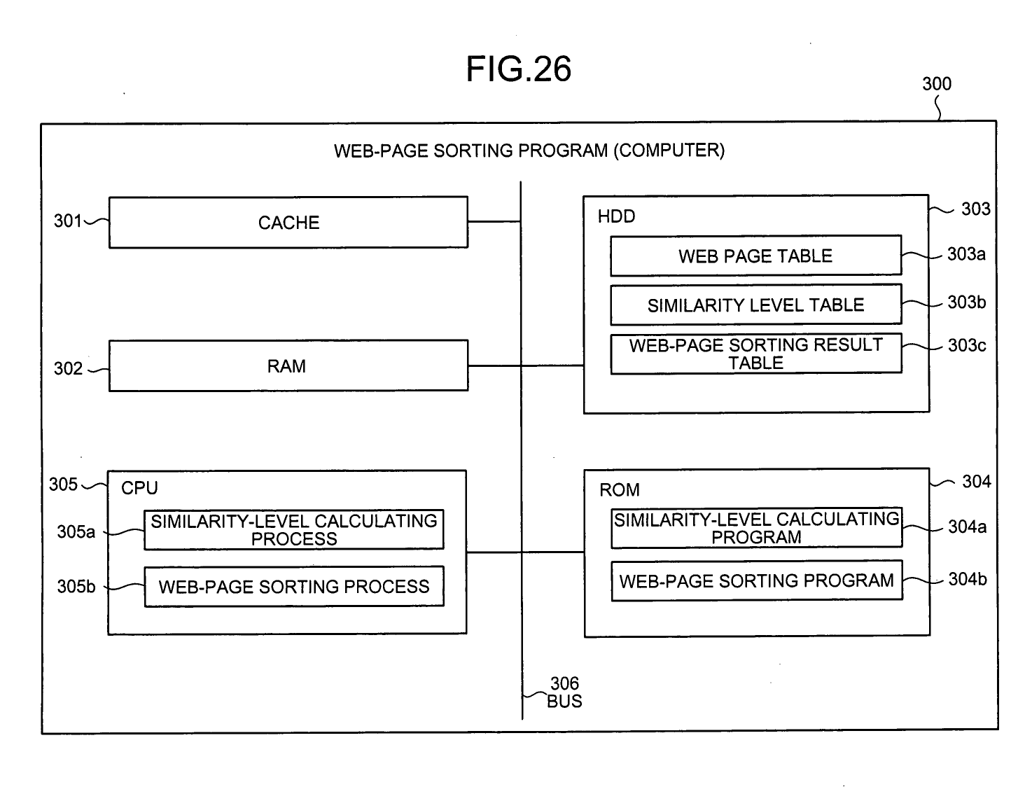

It is possible to realize the various types of processing explained in the description of the third embodiment by causing a computer, such as a personal computer or a work station, to execute a web-page sorting program that is prepared in advance. In the following sections, an example of a computer that executes the web-page sorting program having the same functions as in the third embodiment above will be explained, with reference to FIG. 26. FIG. 26 is a drawing of the computer that executes the web-page sorting program in relation to the third embodiment.

As shown in FIG. 26, a computer 300 is configured so as to include a cache 301, a RAM 302, an HDD 303, a ROM 304, and a CPU 305 that are connected to one another with a bus 306. The ROM 304 stores therein, in advance, the web-page sorting program that achieves the same functions as in the third embodiment. In other words, as shown in FIG. 26, the ROM 304 stores therein a similarity-level calculating program 304a and a web-page sorting program 304b.

The CPU 305 reads and executes the programs 304a and 304b. Accordingly, the programs 304a and 304b become a similarity-level calculating process 305a and a web-page sorting process 305b. The processes 305a and 305b correspond to the similarity-level calculating unit 91 and the web-page sorting unit 92, that are shown in FIG. 18, respectively.

As shown in FIG. 26, included in the HDD 303 are a web page table 303a, a similarity level table 303b, and a web-page sorting result table 303c. The tables 303a, 303b, and 303c correspond to the web-page storing unit 81, the similarity-level storing unit 82, and the web-page sorting result storing unit 83, that are shown in FIG. 18, respectively.

As additional information, the programs 304a and 304b do not necessarily have to be stored in the ROM 304. For example, it is acceptable to store the programs into a “portable physical medium” such as a Flexible Disk (FD), a CD-ROM, an MO disk, a DVD, or an IC card, that can be inserted into the computer 300, or a “stationary physical medium” such as a hard disk drive (HDD) that is provided on the inside or the outside of the computer 300, or “another computer (or a server)” that is connected to the computer 300 via a public circuit, the Internet, a LAN, or a WAN. In these situations, the computer 300 reads the programs and executes the read programs.

Of the various types of processing explained in the description of the exemplary embodiments, it is acceptable to manually perform a part or all of the processing that is explained to be performed automatically. Conversely, it is acceptable to automatically perform, using a publicly-known technique, a part or all of the processing that is explained to be performed manually. In addition, the processing procedures, the controlling procedures, the specific names, and the information including various types of data and parameters that are presented in the text and the drawings can be modified in any form, except when it is noted otherwise.

The constituent elements of the apparatuses shown in the drawings are based on functional concepts. The constituent elements do not necessarily have to be physically arranged in the way shown in the drawings. In other words, the specific mode in which the apparatuses are distributed and integrated is not limited to the ones shown in the drawing. A part or all of the apparatuses may be distributed or integrated functionally or physically in any arbitrary units, according to various loads and the status of use. A part or all of the processing functions offered by the apparatuses may be realized by a CPU and a program analyzed and executed by the CPU, or may be realized as hardware with wired logic.

According to an embodiment of the present invention, it is possible to sort out the advertisement pages more easily, compared to other methods of sorting out advertisement pages in which the person who extracts reputation information needs to specify the URLs. As a result, it is possible to sort out the advertisement pages appropriately without lowering the degree of precision in the results of the analysis obtained by extracting and analyzing the reputation information from the web pages, even though the Internet requires that a huge amount of information be covered thoroughly and also that the information, which is updated daily, be followed up immediately.

Furthermore, according to an embodiment of the present invention, it is possible to sort out the advertisement pages more easily, compared to other methods of sorting out advertisement pages in which the person who extracts reputation information needs to specify the URLS. As a result, it is possible to sort out the advertisement pages appropriately without lowering the degree of precision in the results of the analysis obtained by extracting and analyzing the reputation information from the web pages, even though the Internet requires that a huge amount of information be covered thoroughly and also that the information, which is updated daily, be followed up immediately.

Moreover, according to an embodiment of the present invention, it is possible to sort out the advertisement pages more easily, compared to other methods of sorting out advertisement pages in which the person who extracts reputation information needs to specify the URLs. AS a result, it is possible to sort out the advertisement pages appropriately without lowering the degree of precision in the results of the analysis obtained by extracting and analyzing the reputation information from the web pages, even though the Internet requires that a huge amount of information be covered thoroughly and also that the information, which is updated daily, be followed up immediately.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A computer-readable recording medium that stores therein a computer program that causes a computer to execute sorting out an advertisement page on which an article written by an advertiser is posted, from web pages that are used for posting articles on the Internet, the computer program causes the computer to execute:
holding a word list in which words including unique expressions are registered;
extracting words from text information included in the web pages;
counting a number indicating how many words match between the words contained in the word list held at the holding and the words extracted at the extracting; and
sorting out the advertisement page from the web pages, based on the number counted at the counting.

2. The computer-readable recording medium according to claim 1, wherein
the holding includes holding the word list in which the words including the unique expressions in a large number of categories are registered, and
the counting includes counting number indicating how many words match, in the large number of categories, between the words contained in the word list held at the holding and the words extracted at the extracting.

3. A computer-readable recording medium that stores therein a computer program that causes a computer to execute sorting out an advertisement page on which an article written by an advertiser is posted, from web pages that are used for posting articles in a chronological order on the Internet and that structures at least one web site, the computer program causes the computer to execute:
counting a number indicating how many times articles are posted on at least one web page that structures a single web site; and
sorting out the advertisement page from the web pages based on the number counted at the counting.

4. The computer-readable recording medium according to claim 3, wherein the counting includes counting a number indicating how many times the articles are posted per predetermined unit time.

5. The computer-readable recording medium according to claim 3, wherein the counting includes counting a number indicating how many times the articles are posted for each day of a week.

6. The computer-readable recording medium according to claim 3, wherein the counting includes counting a number of times the articles are posted for each of predetermined time slots.

7. A computer-readable recording medium that stores therein a computer program that causes a computer to execute sorting out an advertisement pages on which an article written by an advertiser is posted, from web pages that are used for posting articles in a chronological order on the Internet and that structures at least one web site, the computer program causes the computer to execute:
calculating a level of similarity among articles posted on at least one web page that structures a single web site; and
sorting the advertisement page from the web pages based on calculated level of similarity.

8. The computer-readable recording medium according to claim 7, wherein the calculating includes calculating the level of similarity based on similarity in amounts of writing in the articles.

9. The computer-readable recording medium according to claim 7, wherein the calculating includes calculating the level of similarity based on similarity in contents of the articles.

10. A web-page sorting apparatus that sorts out an advertisement page on which an article written by an advertiser is posted, from web pages that are used for posting articles on the Internet, the web-page sorting apparatus comprising:
a word-list holding unit that stores therein a word list in which words including unique expressions are registered;
a word extracting unit that extracts words from text information included in the web pages;
a quantity counting unit that counts a number indicating how many words match between the words contained in the word list and the words extracted by the word extracting unit; and
a web-page sorting unit that sorts out the advertisement page from the web pages based on the number counted by the quantity counting unit.

11. A web-page sorting apparatus that sorts out an advertisement page on which an article written by an advertiser is posted, from web pages that are used for posting articles in a chronological order on the Internet and that structures at least one web site, the web-page sorting apparatus comprising:
an article posting-number counting unit that counts a number indicating how many times articles are posted on at least one web page that structures a single web site; and
a web-page sorting unit that sorts out the advertisement page from the web pages, based on the number indicating how many times the articles are posted that is counted by the article posting-number counting unit.

12. The web-page sorting apparatus according to claim 11, wherein the article posting-number counting unit counts a number indicating how many times the articles are posted for each day of a week.

13. The web-page sorting apparatus according to claim 11, wherein the article posting-number counting unit counts a number of times the articles are posted for each of predetermined time slots.

14. A web-page sorting apparatus that sorts out an advertisement page on which an article written by an advertiser is posted, from web pages that are used for posting articles in a chronological order on the Internet and that structures at least one web site, the web-page sorting apparatus comprising:
a similarity-level calculating unit that calculates a level of similarity among a plurality of articles posted on at least one web page that structures a single web site; and
a web-page sorting unit that sorts out the advertisement page from the web pages based on the level of similarity calculated by the similarity-level calculating unit.

15. The web-page sorting apparatus according to claim 14, wherein the similarity-level calculating unit calculates the level of similarity based on similarity in contents of the articles.

16. A method of sorting out an advertisement page on which an article written by an advertiser is posted, from web pages that are used for posting articles on the Internet, the method comprising:
holding a word list in which words including unique expressions are registered;
extracting words from text information included in the web pages;
counting a number indicating how many words match between the words contained in the word list held at the holding and the words extracted at the extracting; and
sorting out the advertisement page from the web pages based on the number counted at the counting.

17. The method according to claim 16, wherein the counting includes counting a number indicating how many times the articles are posted for each day of a week.

18. A method of sorting out an advertisement page on which an article written by an advertiser is posted, from web pages that are used for posting articles in a chronological order on the Internet and that structures at least one web site, the method comprising:
counting a number indicating how many times articles are posted on at least one web page that structures a single web site; and
sorting out the advertisement page from the web pages based on the number counted at the counting.

19. The method according to claim 18, wherein the calculating includes calculating the level of similarity based on similarity in contents of the articles.

20. A method of sorting out an advertisement page on which an article written by an advertiser is posted, from web pages that are used for posting articles in a chronological order on the Internet and that structures at least one web site, the web page sorting method comprising:
calculating a level of similarity among articles posted on at least one web page that structures a single web site; and
sorting the advertisement page from the web pages, based on the level of similarity calculated at the calculating.
